(19) United States
(12) Patent Application Publication
(10) Pub. No.: US 2016/0148216 A1
(43) Pub. Date: May 26, 2016

(54) AUDIT PROTOCOL DATABASE SYSTEM FOR SAFETY AUDITS

(71) Applicant: Phillip Fountain, Racine, WI (US)

(72) Inventor: Phillip Fountain, Racine, WI (US)

(21) Appl. No.: 14/942,261

(22) Filed: Nov. 16, 2015

Related U.S. Application Data
(60) Provisional application No. 62/083,766, filed on Nov. 24, 2014.

(51) Int. Cl. G06Q 30/00; G06F 17/30

(52) U.S. Cl. CPC G06Q 30/018; G06F 17/30011; G06F 17/30312

(57) ABSTRACT

A computerized, cloud-based, integrated audit protocol database system for safety audits including a safety database configured to store at least one safety requirement which is completed and updated by one or more users and a compliance audit protocol component that stores and displays industry, regulatory and professional documentation for each safety requirement. The database can be used for machine safety audits.

### CROSS-REFERENCE TO RELATED APPLICATION

This application claims priority based on U.S. provisional patent application No. 62/083,766 filed on Nov. 24, 2014.

### FIELD

The present invention relates to software databases and more particularly to an audit protocol database system for safety audits.

### BACKGROUND

This software program is an improvement in the area of audit protocol database systems for safety audits. There are many audit databases available for numerous industries. However, there is a need in the market for an audit protocol database system specifically for safety audits. It is to this need that this invention is directed.

It would be desirable to have an audit protocol database system for safety audits which is a computerized, cloud-based, integrated audit protocol database system for safety audits including a safety database which can store specific safety requirements and is able to be completed, changed or updated by one or more users. It would be also desirable to provide a system with a compliance audit protocol component that stores and displays industry, regulatory and professional documentation for each safety requirement so a user of the system can prepare and perform internal gap analysis and audits.

This inventive software program overcomes certain problems and shortcomings in the prior art, including those mentioned above and others, and provides advantages for an audit protocol database system for safety audits not previously provided.

### SUMMARY

This device is an improvement in a computerized, cloud-based, integrated audit protocol database system for safety audits of the type including a safety database configured to store at least one safety requirement which is completed and updated by the organization producing the application for a given industry and a compliance audit protocol component that stores and displays industry, regulatory and professional documentation for each safety requirement. A user of the system can prepare and perform internal gap analysis and audits.

In highly preferred embodiments, the safety requirements are machine safety requirements. It is preferred that the machine safety audits are for the aviation industry, medical industry or energy industry or any industry that has safety concerns which need to be met.

Preferably, the database system also includes a database of auditor base information questions for personnel groupings within a department or company. It is also preferable that the safety database can include or exclude a set of requirements if chosen by the user. It is also highly preferable that at least one safety requirement can be completed, updated or manipulated in other ways at the same time by more than one user so as to enable multiple users to work on the system at the same time.

It is highly preferred that the present inventive software application is cloud based and is for use primarily with PC/MAC or tablet devices. In some embodiments, a copy of the application can be stored on a user's device during times when a web connection is not available.

It is also highly preferable that the inventive software provide a means to accomplish audits sufficiently through a process that produces high-level results. The inventive software focuses on an audit protocol that displays supporting industry, regulatory, and professional documentation next to each requirement. Based on the displayed information, a set of Auditor Base Information questions can be established for various personnel groupings within a department or company.

The Auditor Base Information can then be imported into a department or company record-set and adjusted as needed, before performing an audit. Comments or evidence of non-conformities, element analysis, and notation of element findings can be recorded. Each requirement can then be evaluated for conformity by a user or multiple users.

When the audit is complete, the user(s) has the option of selecting the “Report PDF” button. The inventive software then checks for audit completion before generating the final PDF report and/or uploading the report to a selected server.

There are three main types of users that the inventive system is specifically written for; they are operators, service providers and auditors.

Operators are usually a department or company that would use the inventive software to develop or maintain a particular business system. The operator can also prepare and perform internal GAP Analysis or audits to qualify their system particularly before an audit. Operators can perform as many internal audits as they would need within the protocol cycle. Other operators in different industries may have different cycle periods or some industries may not have cycle periods at all.

Service Providers assist Operators in the development of operator manuals, cultures, systems, processes, and procedures. The service provider may also provide GAP Analysis and test audits. Service Providers would use the inventive software to maintain and update the services they provide to their customers.

Auditors would use the inventive software to maintain and update the services provided to their customers as well as establish and maintain question styles used to perform audits.

Some key processes of the inventive software application are, but not limited to: (1) Hazard Identification—a method for identifying hazards related to your organization; (2) Occurrence Reporting—a process for the acquisition of safety data; (3) Risk Management—a standard approach for assessing risks and for applying risk controls; (4) Performance Measurement—management tools for analyzing whether the organization's safety goals are being achieved; and (5) Quality/Safety Assurance—processes based on quality management principles that support continuous improvement of the organization's safety performance.

The inventive software provides for more informed decision-making; improves safety by reducing risk of accidents; provides for better resource allocation that results in increased efficiencies and reduced costs; strengthens corporate culture; and demonstrates corporate due-diligence.

In the present application the term “gap analysis” or “GAP Analysis” is used as is customary in the industry to one skilled in the art. Specifically, “gap analysis” or “GAP Analysis” as used herein means the comparison of actual performance with potential or desired performance. This is used to determine if the specific requirements of the business are being met.

### BRIEF DESCRIPTION OF THE DRAWINGS

The drawings illustrate a preferred embodiment including the above-noted characteristics and features of the device. The device will be readily understood from the descriptions and drawings. In the drawings:

FIGS. 1-35 are software screen shots of the various forms and templates within the database which detail the key features of the inventive software system.

### DETAILED DESCRIPTION

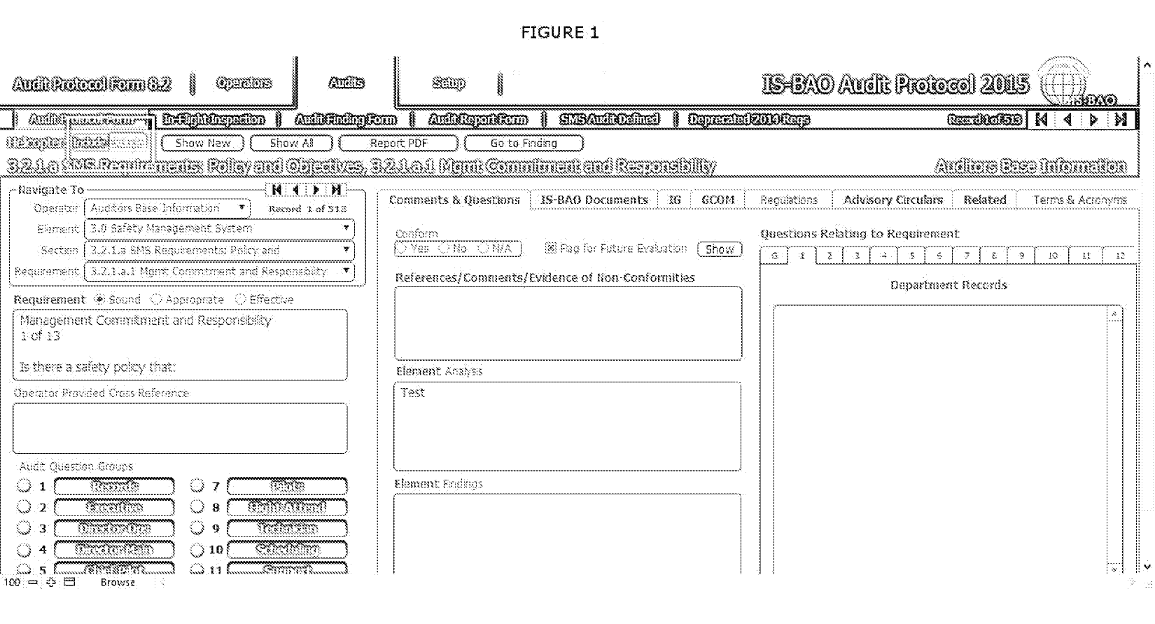

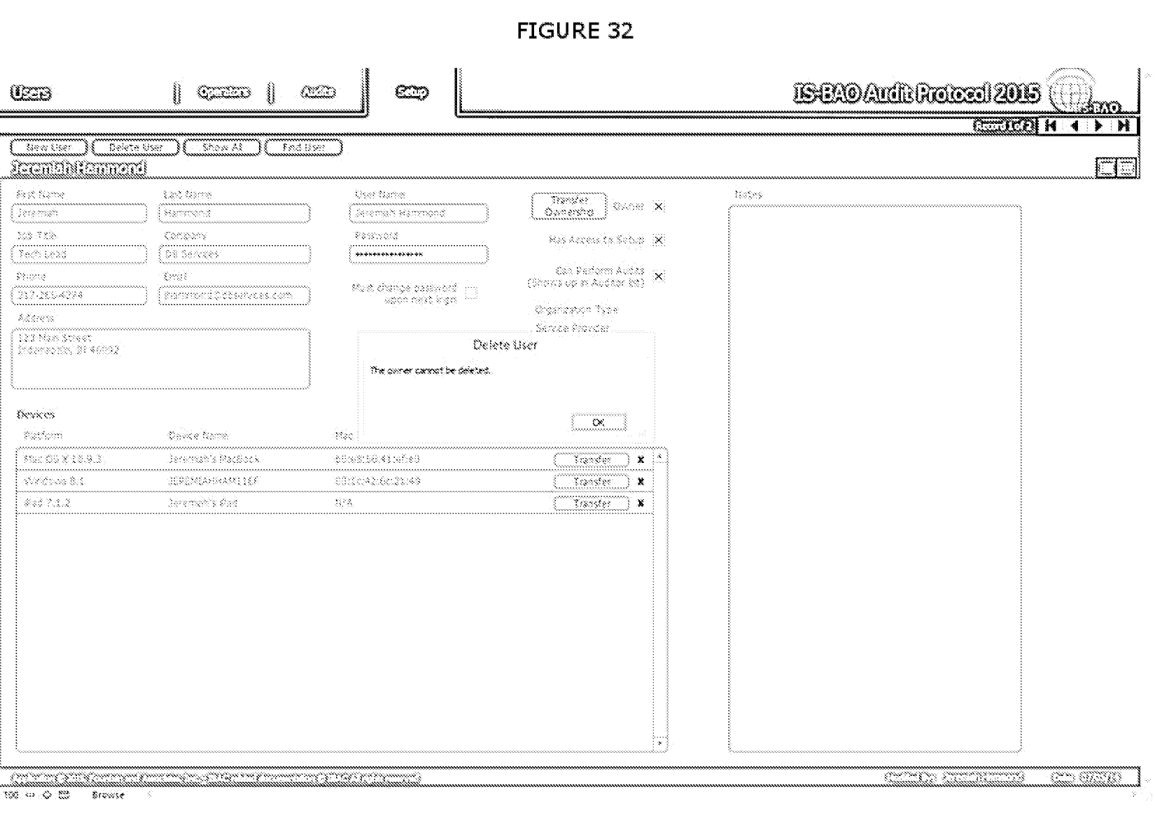

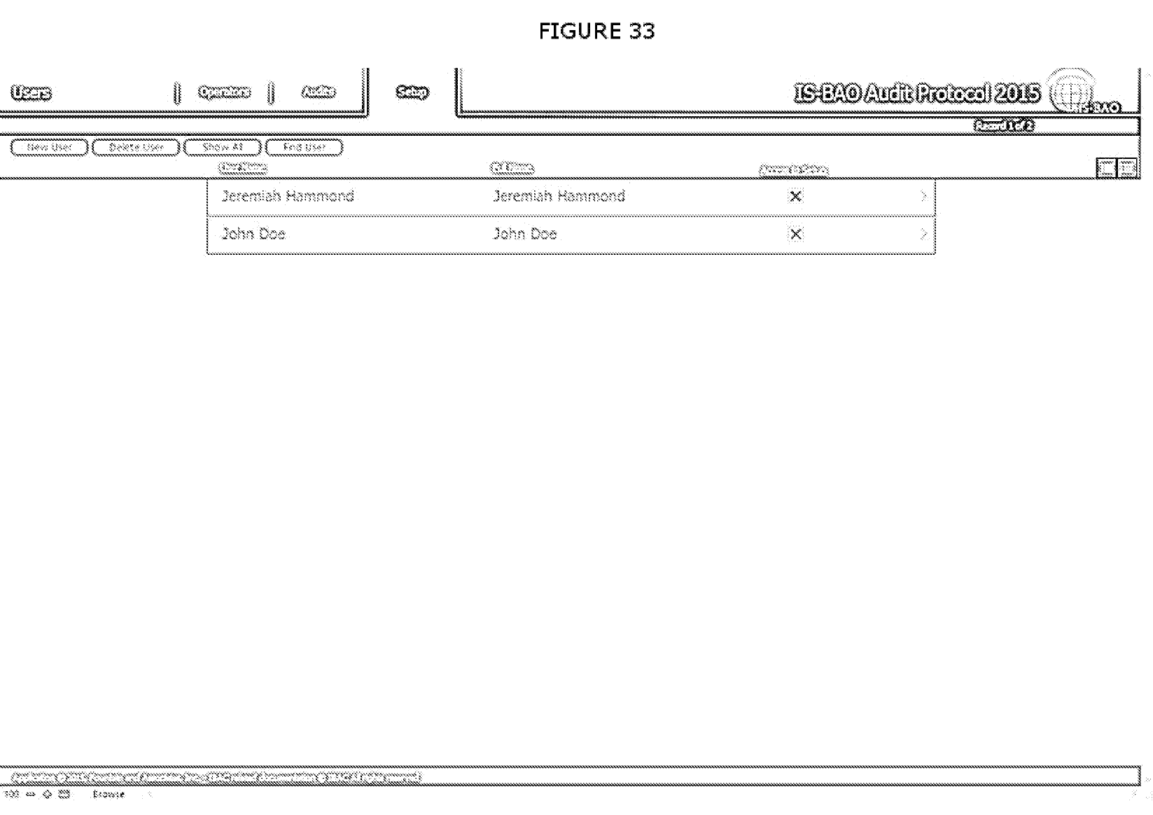

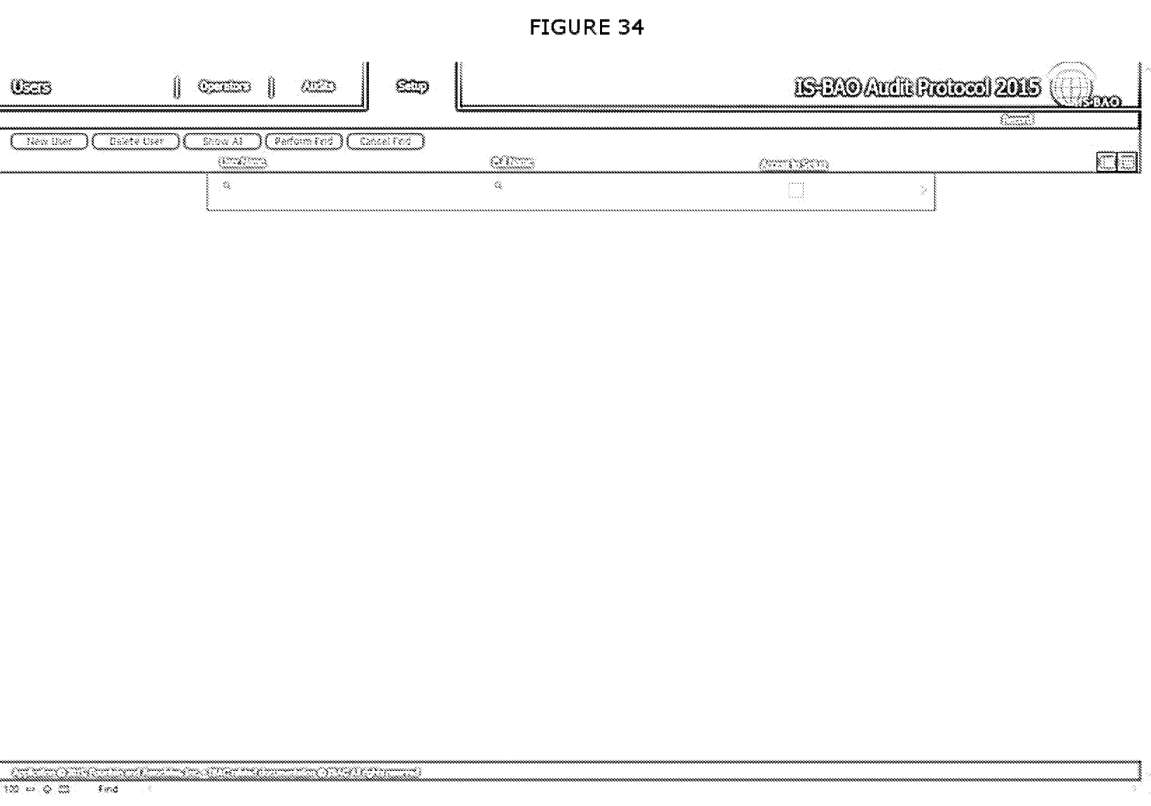

FIGS. 1-35 illustrate various screen shots of the computerized, cloud-based, integrated audit protocol database system for safety audits including a safety database configured to store at least one safety requirement which is completed and updated by one or more users; and a compliance audit protocol component that stores and displays industry, regulatory and professional documentation for each safety requirement and allows the user of the system to prepare and perform internal gap analysis and audits

FIG. 1 is a screen shot of the Audit Protocol Form of the system illustrating the “Include/Exclude” set of requirements in the protocol. This function is used to include or exclude certain criteria. An example of this would be a company performing a machinery audit. If a company does not have helicopters this function can be used to exclude specifically helicopters.

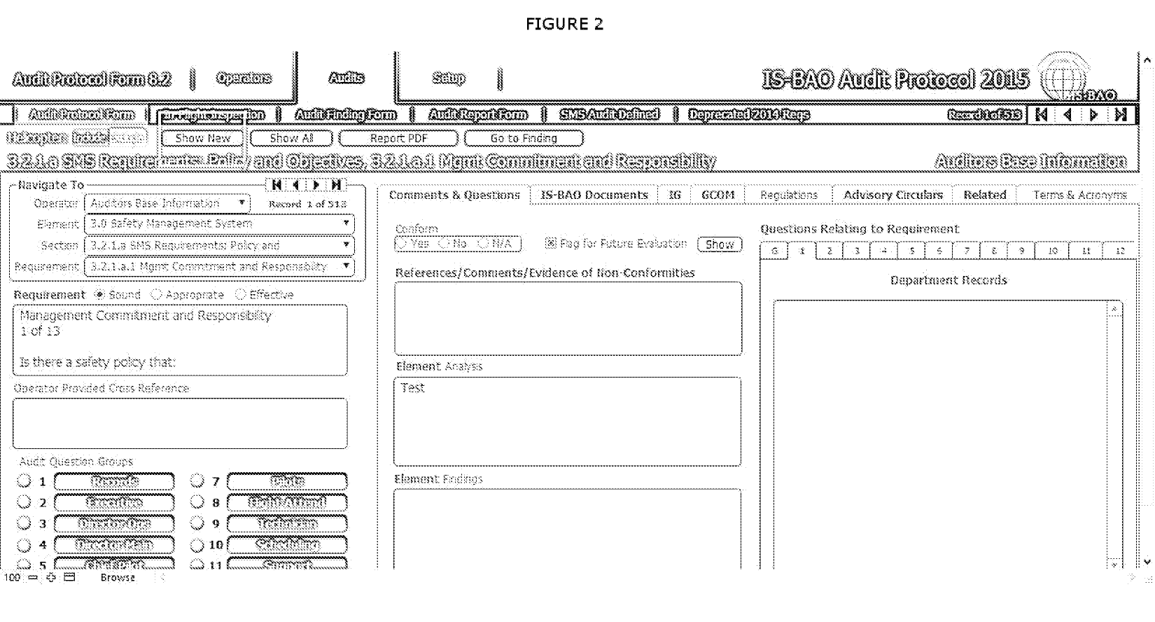

FIG. 2 is a screen shot of the Audit Protocol Form of the system illustrating the “Show New” feature which displays only new or changed requirements that have changed from the previous cycle. This provides the user the convenience to update their documentation and auditing procedures.

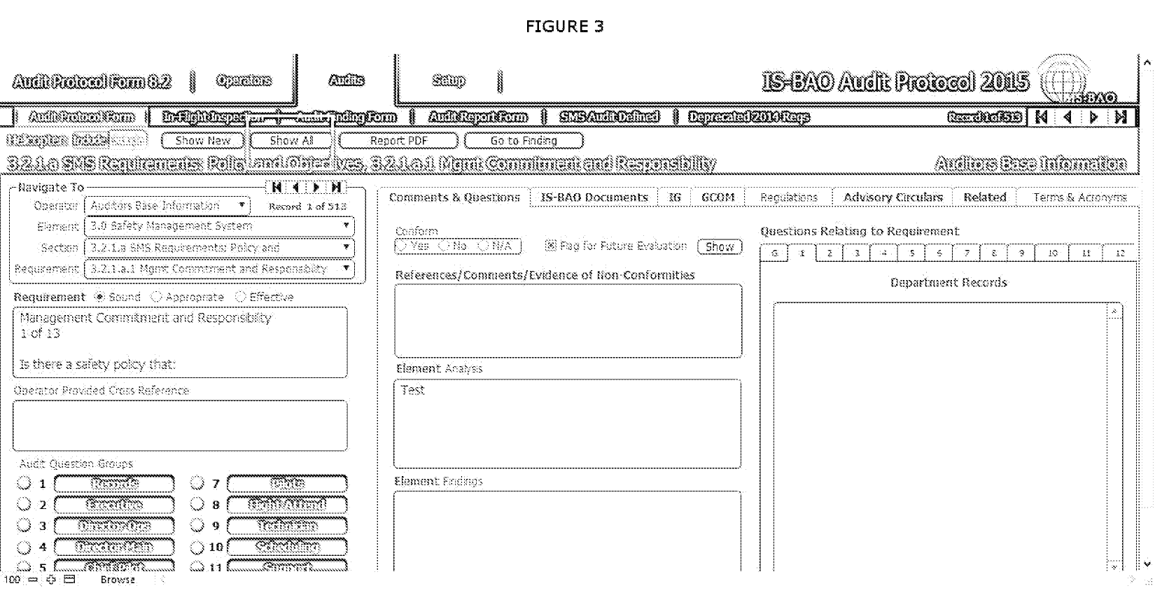

FIG. 3 is a screen shot of the Audit Protocol Form of the system illustrating the “Show All” feature which displays the entire set of requirements within the protocol.

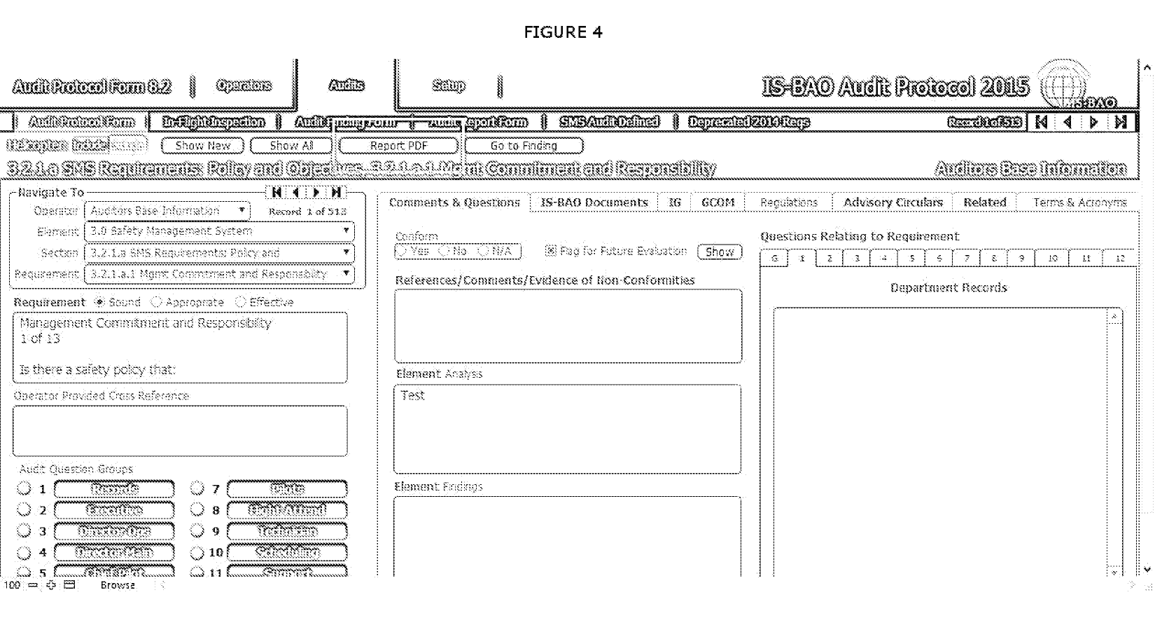

FIG. 4 is a screen shot of the Audit Protocol Form of the system illustrating the “Report PDF” feature. This feature sets up two processes before the creation of a final report. First, this feature checks all form fields for complete information. If an empty field exists, the user will be asked if they want to continue without the correct information. If the user wishes the information to be included, the application will step the user through each field requiring attention. Second, depending on the action the user takes, the report will be completed. The final report can be presented in two formats, PDF and electronic upload to the user's server.

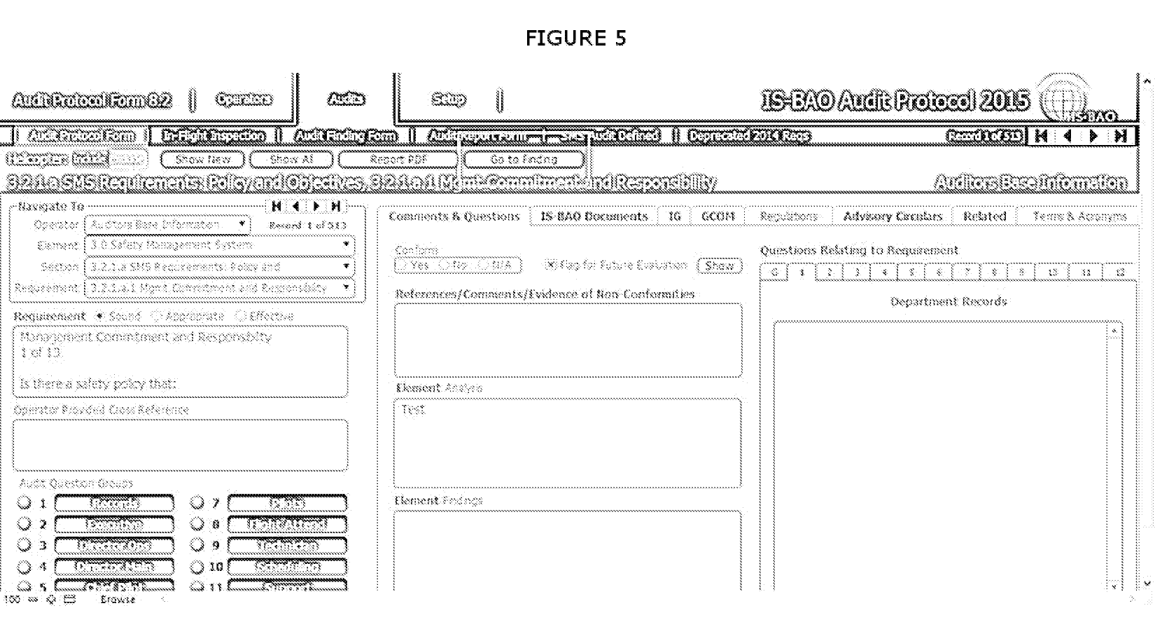

FIG. 5 is a screen shot of the Audit Protocol Form of the system illustrating the “Go to Finding” feature. This feature takes the user to the Audit Finding Form where a new finding can be created. When selecting this button the requirement identification is placed in the appropriate field for referencing purposes. Selection of the Audit Protocol Form button returns the user to the position where the finding was found.

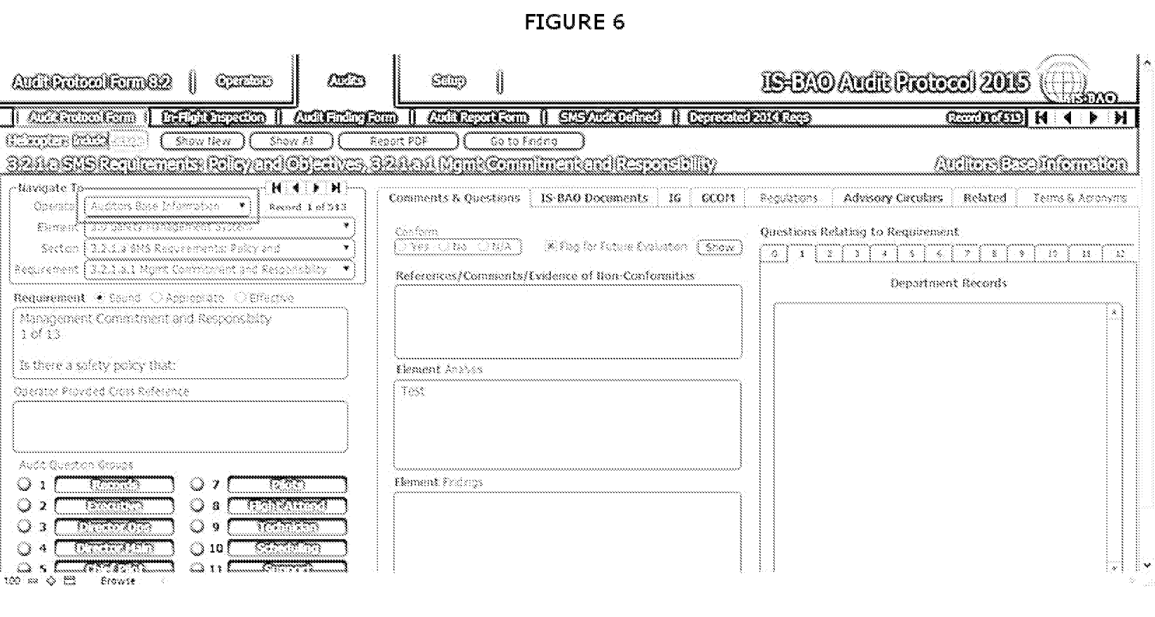

FIG. 6 is a screen shot of the Audit Protocol Form of the system illustrating the “Navigate To” feature. The purpose of this record set is to navigate to Operator Record sets with the default being the “Auditors Base Information.” Additional record sets can be created in the operator tab at the top left of the screen shot. The other fields within the “Navigate To” section are used to navigate to the desired Element, Section, or Requirement of the protocol and to store base information that can be copied into other record sets and used to accomplish audits.

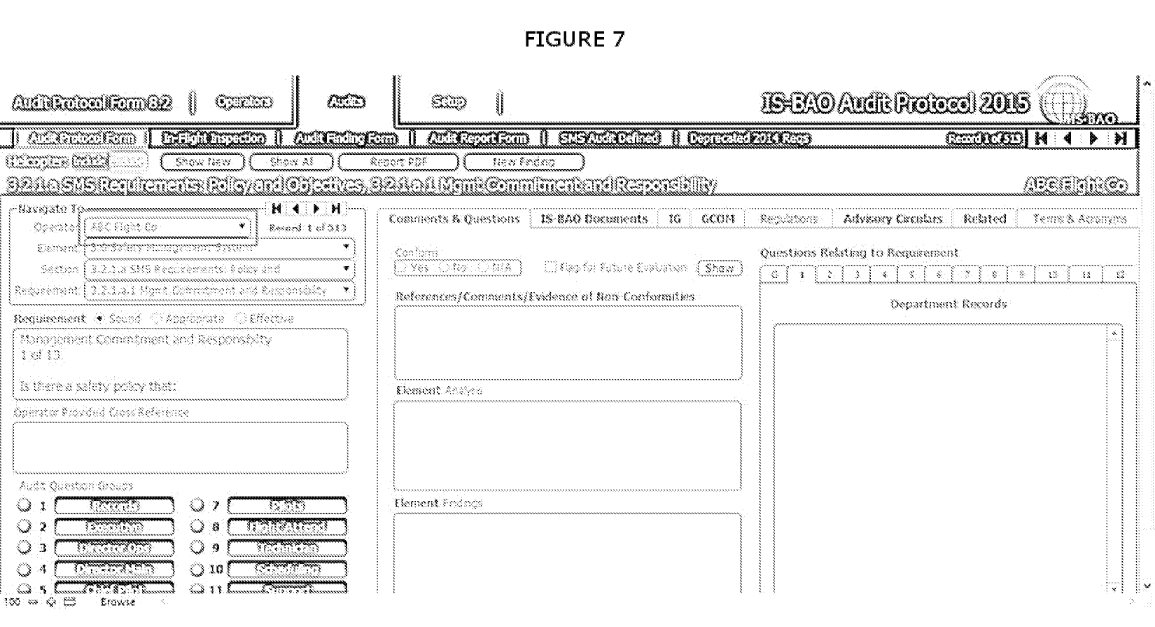

FIG. 7 is a screen shot of the Audit Protocol Form of the system illustrating the number of records in the table. A separate feature is the record set feature. A record set is a controlled record delegated to a named audit. A record is typically one of many records assigned to a named audit. The creation and naming of record sets are accomplished from within the Operators section.

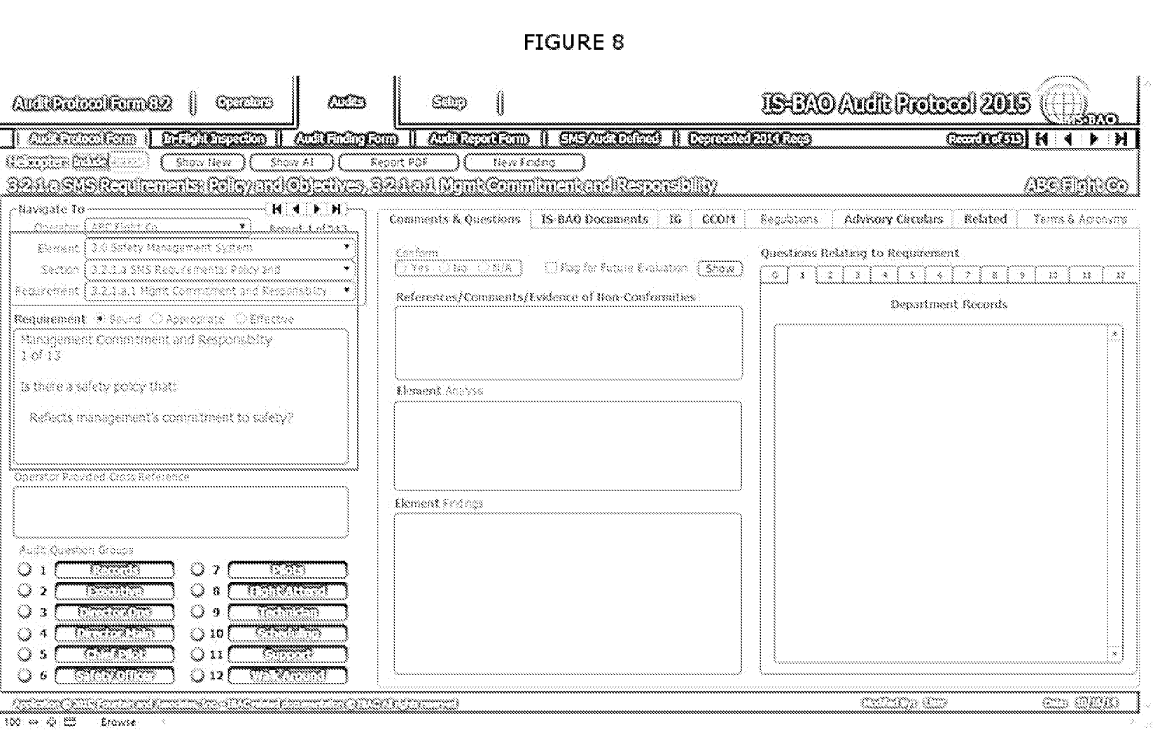

FIG. 8 is a screen shot of the Audit Protocol Form of the system illustrating the “Requirement” feature. The protocol is displayed by individual requirements and referenced by element, section and requirement for navigation purposes. The non-editable indicators (unable to be edited by the end user) are used to identify what is to be expected from the displayed requirement. These indicators can only be edited by the producer of the application and not the operator, service provider or auditor.

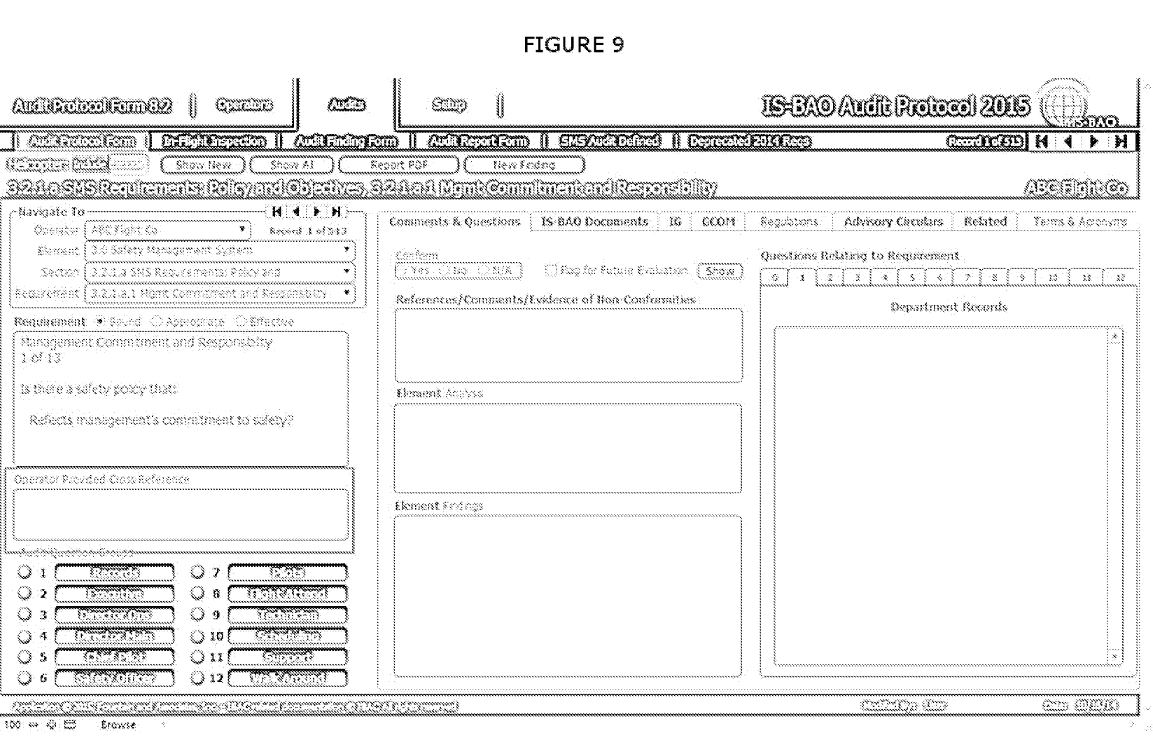

FIG. 9 is a screen shot of the Audit Protocol Form of the system illustrating the “Operator Provided Cross Reference” feature. Operators can place their manual cross-references in this section to show policies, systems and procedures used to comply with the requirement. The cross references can then be exported and emailed to an auditor for importing into their software for evaluation before an audit. When a new application cycle is available, the cross reference can be imported into the current cycle and updated as needed to comply with new or changed requirements.

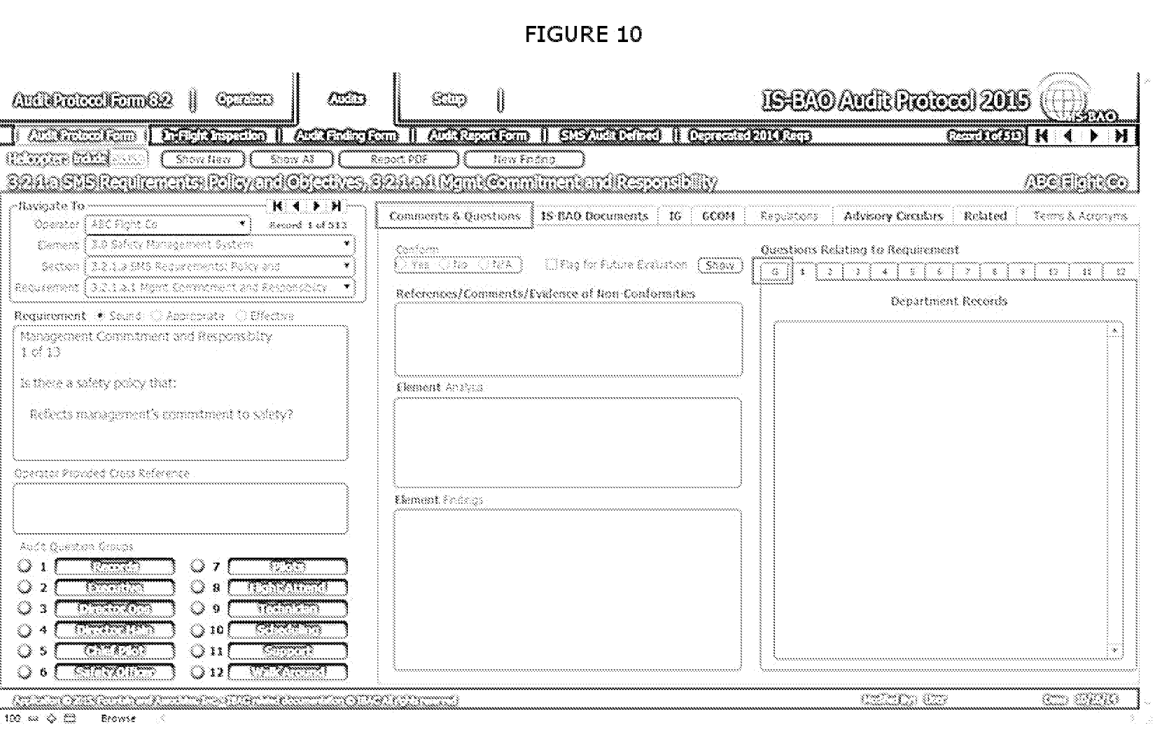

FIG. 10 is a screen shot of the Audit Protocol Form of the system illustrating the “Comments & Questions” feature which includes GAP Analysis. This feature provides the user the ability to look for gaps within the department and/or company policies, systems, and procedures. This feature can contain information on items to look for or helpful information that the operator can use to improve their processes.

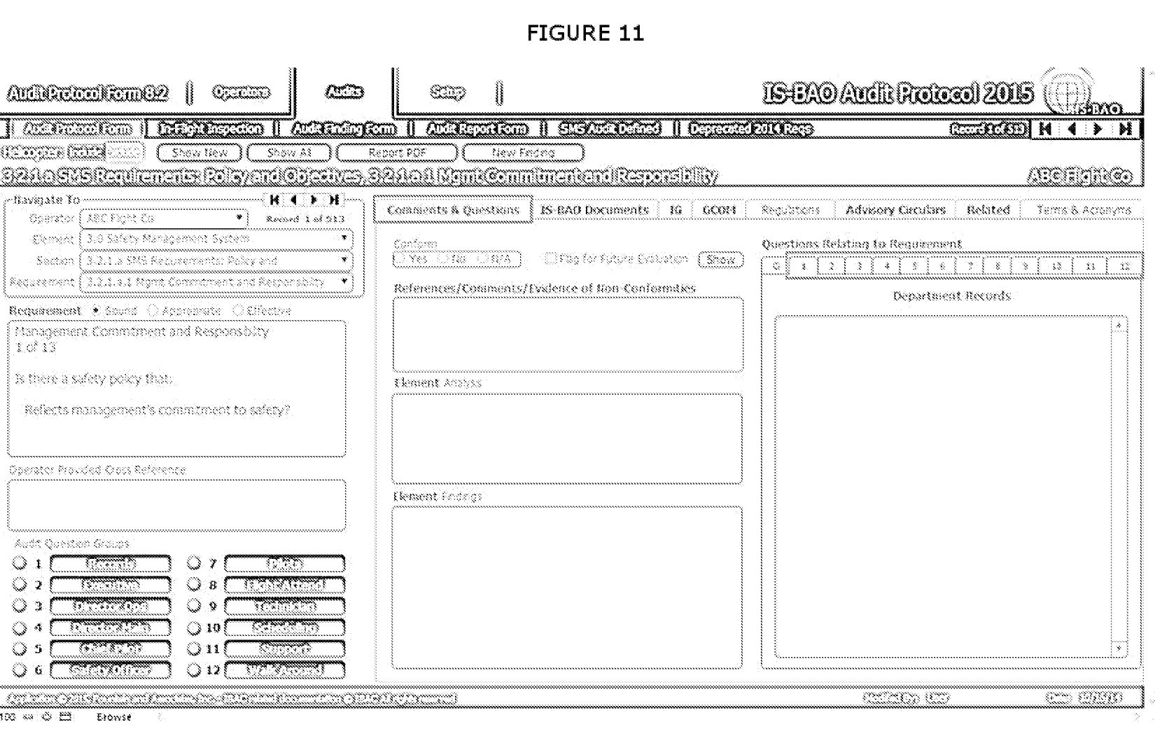

FIG. 11 is a screen shot of the Audit Protocol Form of the system illustrating the “Questions Relating to Requirement” feature. The twelve tabs in this section are used to post questions to each personnel group for each requirement in the protocol. When a question is entered into the field, the record becomes a subset that can be selected from the buttons in the Audit Question Group.

The system also includes a question group strategy feature. With this feature an auditor can set up a questioning style that determines the intentions of the department's management and then establish a questioning style for the personnel side that validates the effectiveness of the department's management. This feature provides a dynamic means to change the interviewing process within another question group and provides an advantage to the auditing process.

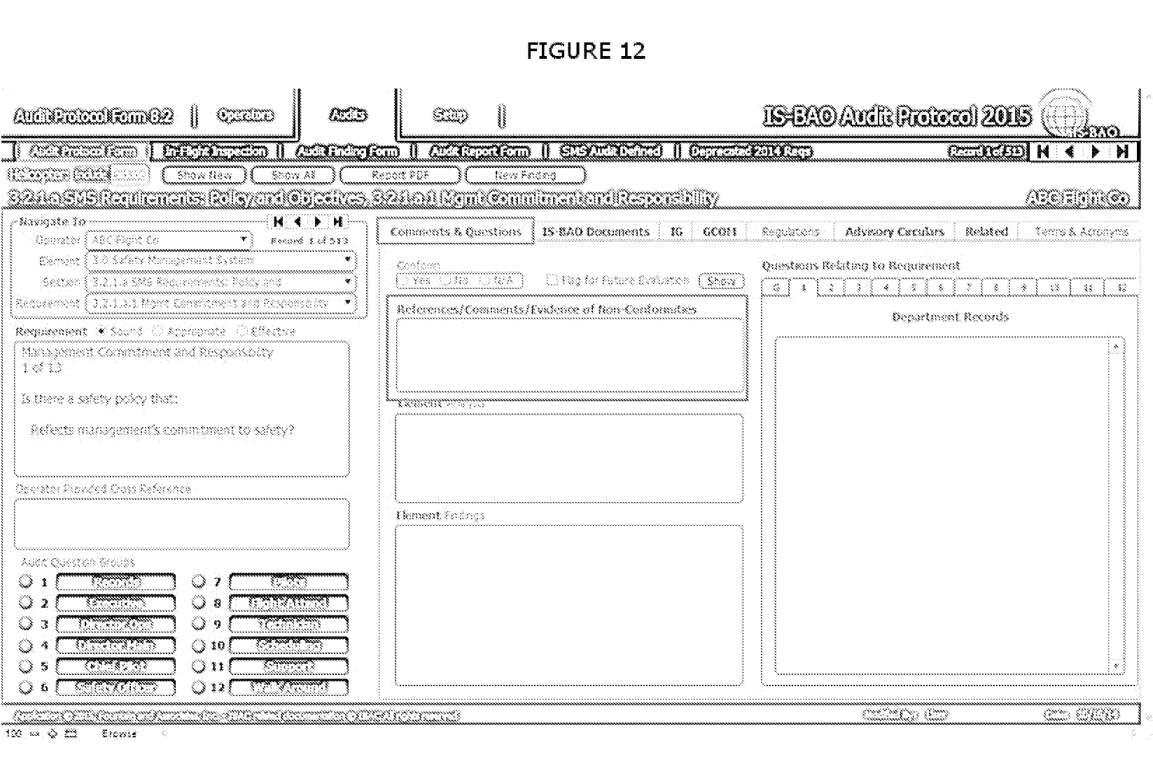

FIG. 12 is a screen shot of the Audit Protocol Form of the system illustrating the “References/Comments/Evidence of Non-Conformities” feature. This section allows the auditor to place comments and evidence of non-conformity relating to the requirement displayed. The content in this field will change with each record.

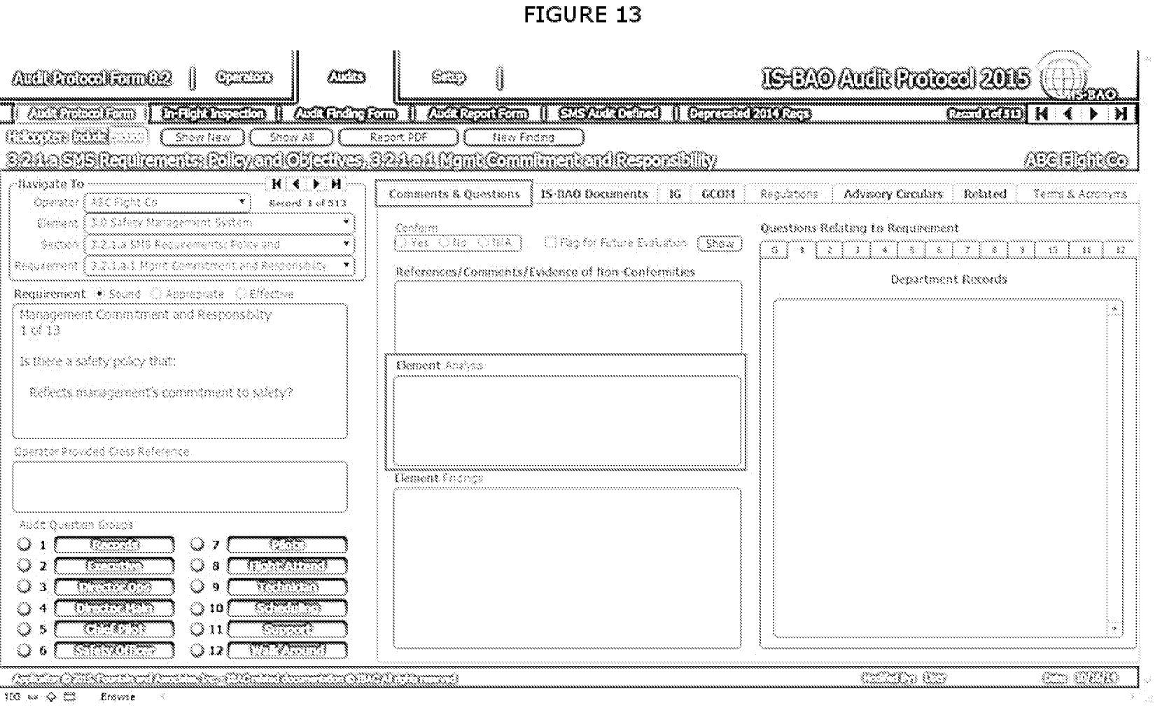

FIG. 13 is a screen shot of the Audit Protocol Form of the system illustrating the “Elements Analysis” feature. The Element Analysis field is for general comments relating to the element. Content in this field will not change until the next element is displayed by a user.

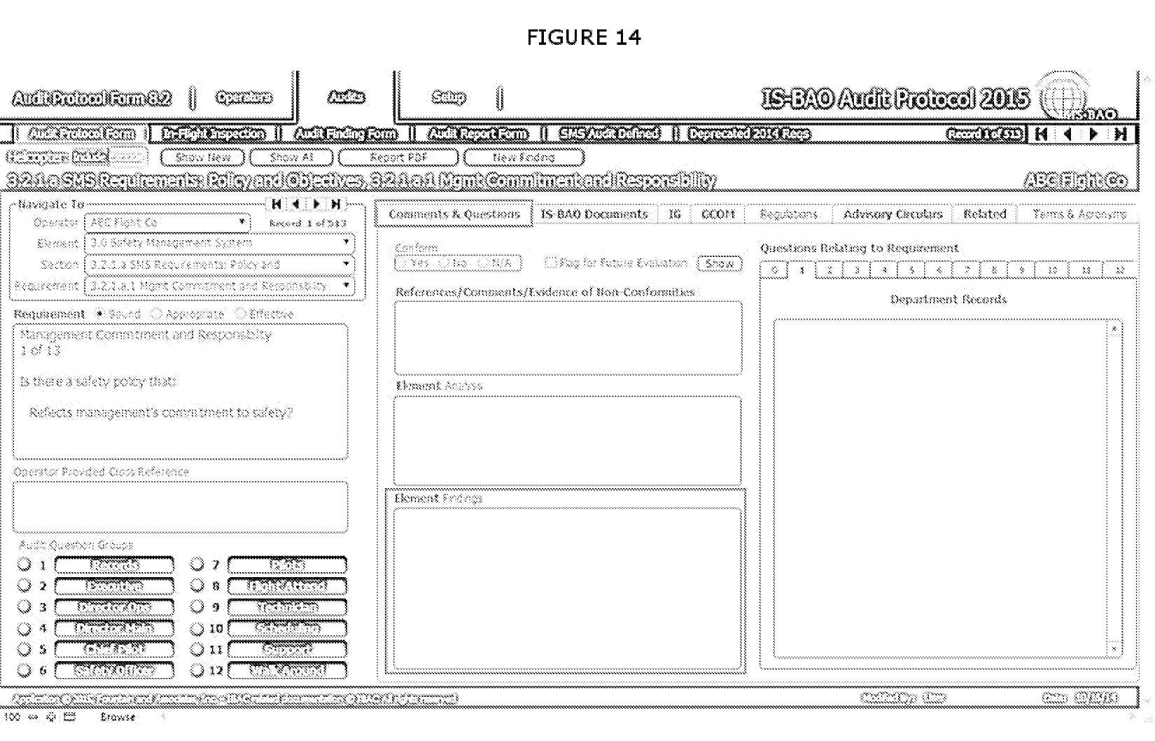

FIG. 14 is a screen shot of the Audit Protocol Form of the system illustrating the “Elements Findings” feature. The Element Findings section is a summary field containing finding information from the reference/comments/evidence fields.

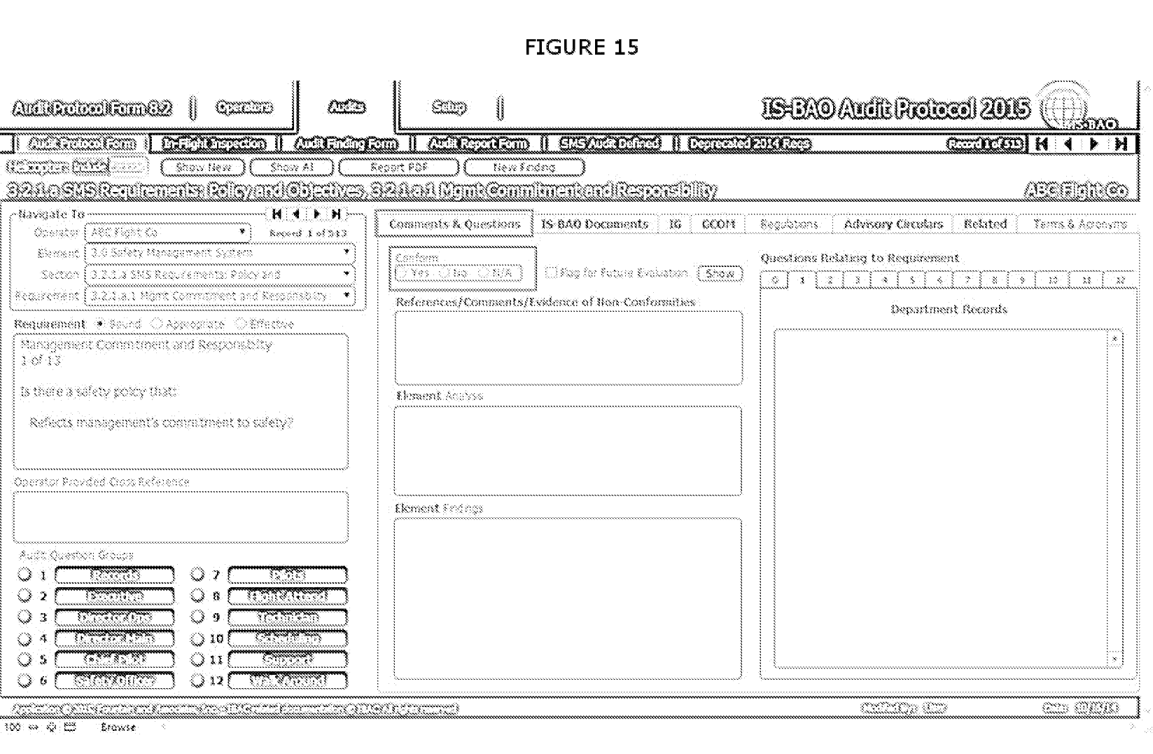

FIG. 15 is a screen shot of the Audit Protocol Form of the system illustrating the “Conform” feature. Radio buttons are provided for each requirement to indicate operator compliance. The appropriate button must be selected before a final report can be created.

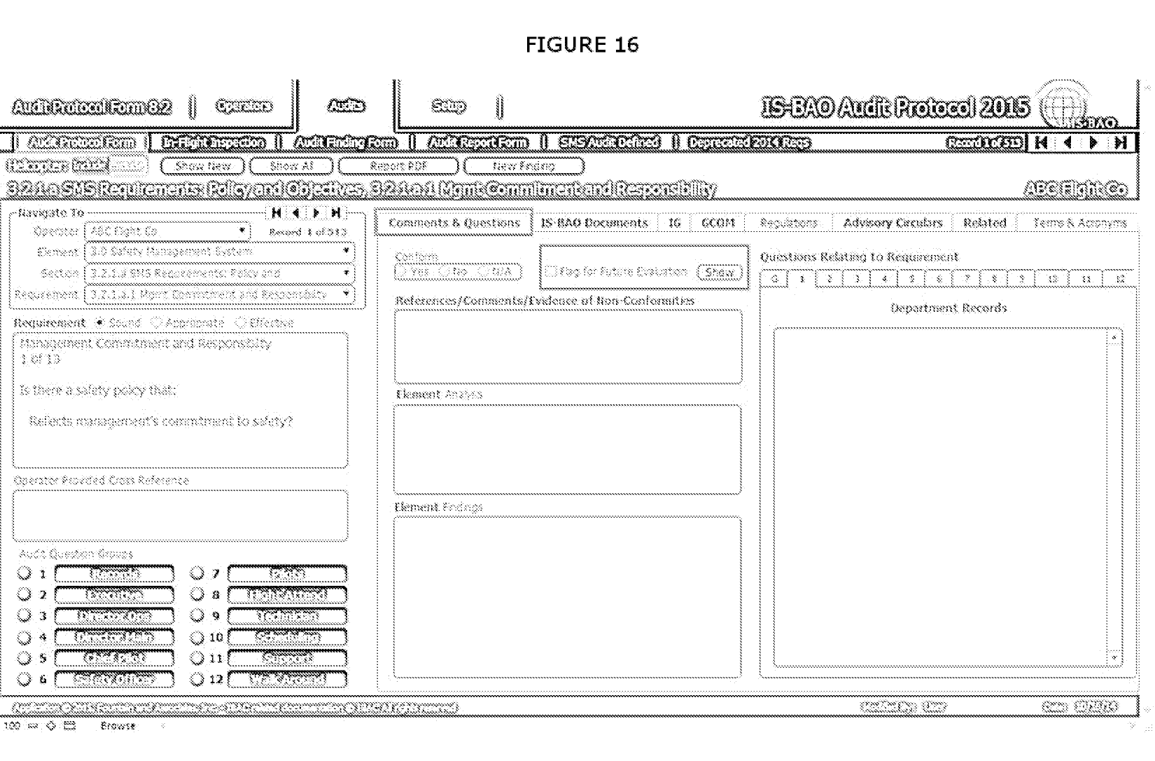

FIG. 16 is a screen shot of the Audit Protocol Form of the system illustrating the “Future Evaluation” feature. A check box is provided for each requirement that may be of interest for future evaluation during the auditing process. Selecting the “Show” button displays a subset of requirement records that have the check box flagged.

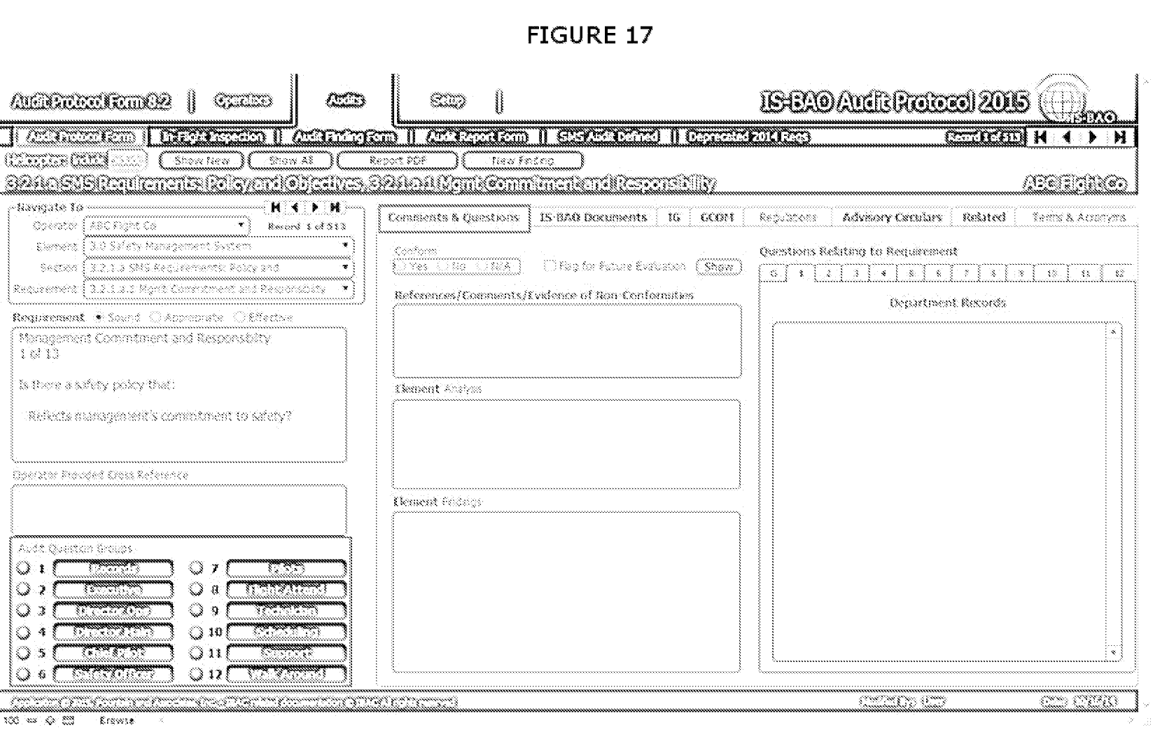

FIG. 17 is a screen shot of the Audit Protocol Form of the system illustrating the “Audit Question Groups” feature. These buttons are used to select a subset of requirements that have been flagged by the posting of questions in the associated question tab. The auditor can then navigate through the record set to interview personnel from that group. When a requirement is displayed, the amber dots next to each question button will show green to indicate the personnel groups containing questions relating to the displayed requirement.

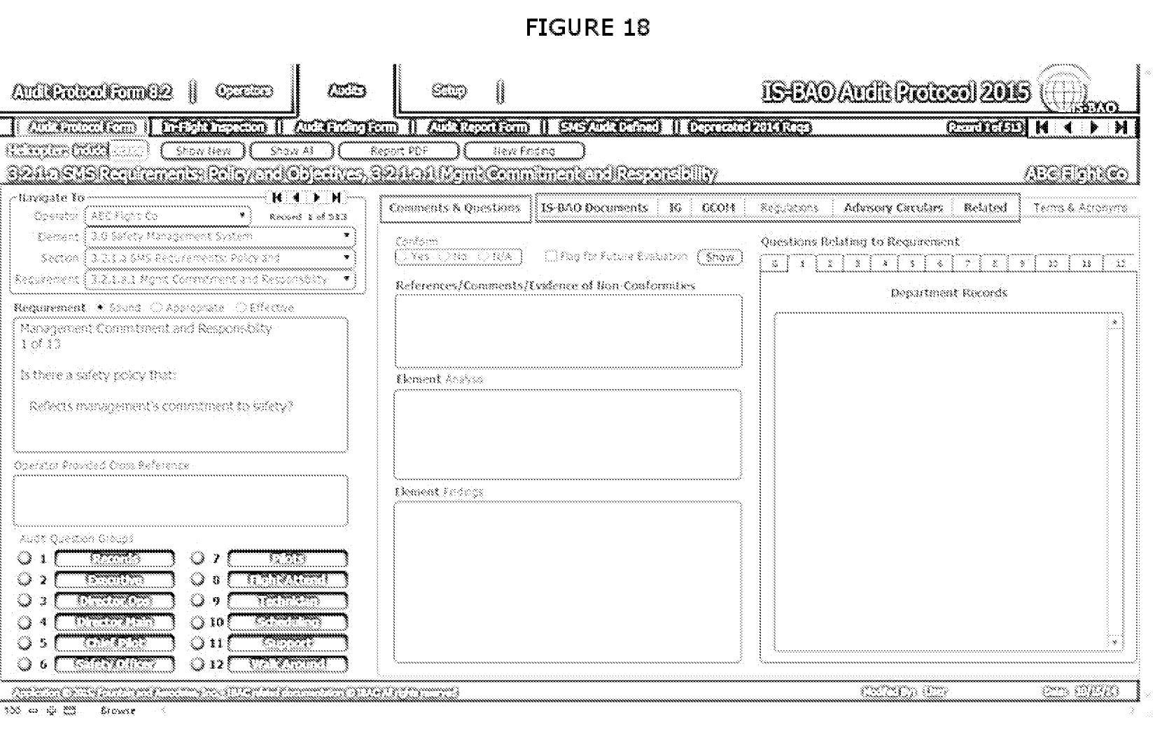

FIG. 18 is a screen shot of the Audit Protocol Form of the system illustrating the “Protocol Supporting Documentation” feature. Next to the “Comments & Questions” tab is a group of tabs containing documentation supporting the currently displayed requirement. Relating information in this manner helps promote a better understanding for all stakeholders involved in company processes. Operators can better prepare their systems, processes, policies and procedures. Tabs displaying green text within tabs that are green indicate that the tab contains documentation.

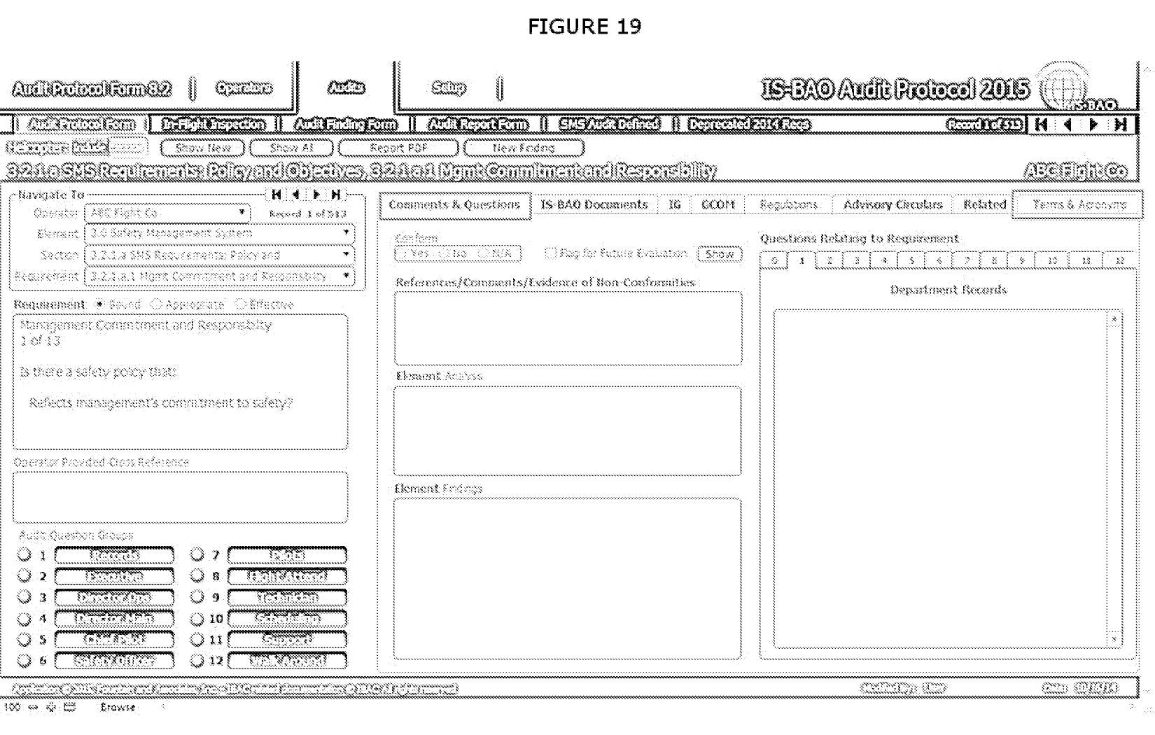

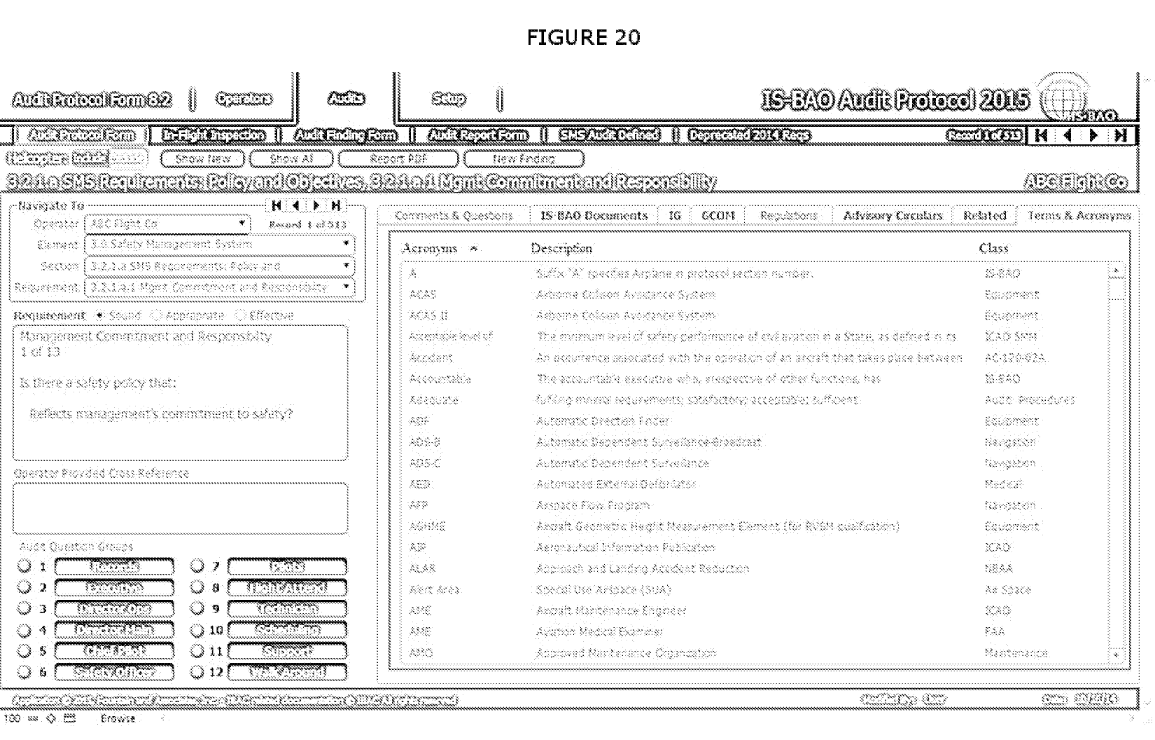

FIGS. 19-20 are screen shots of the Audit Protocol Form of the system illustrating the “Terms & Acronyms” feature. This feature simply displays related terms and acronyms by acronym or class indexes related to a particular industry.

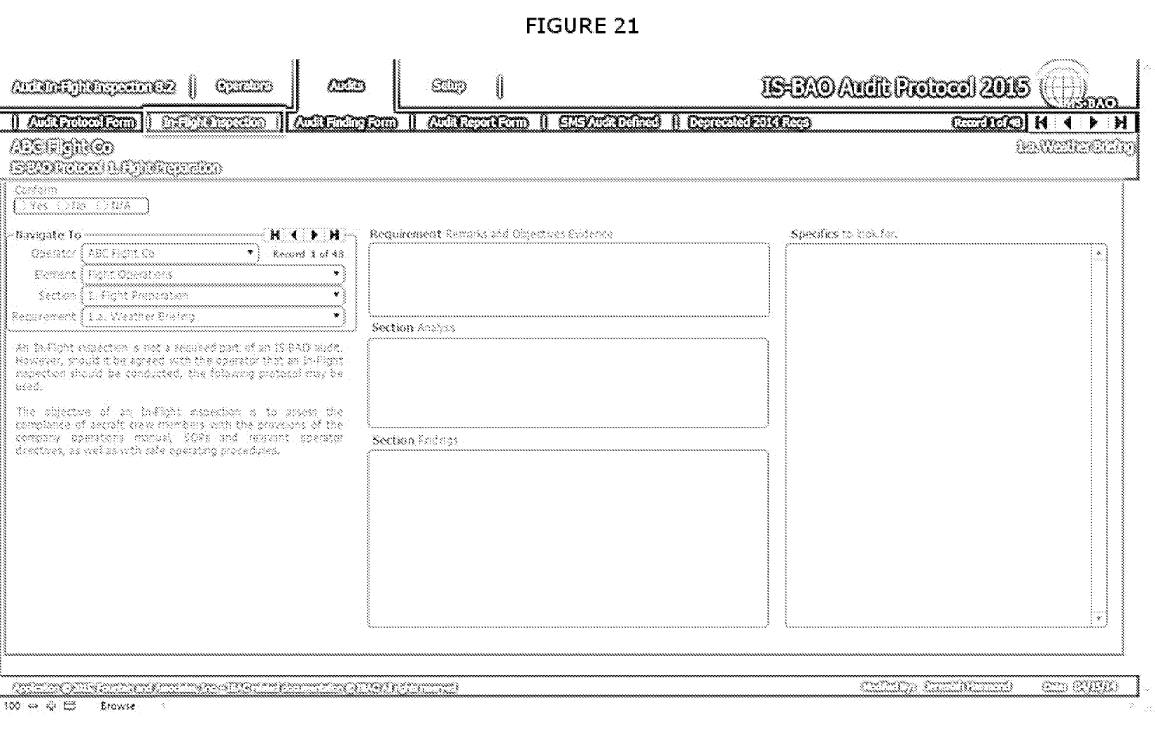

FIG. 21 is a screen shot of the system illustrating the “Secondary Audit” feature. Next to the Audit Protocol Form, at the top left side, is a secondary audit form. In the embodiment shown in the screen shot, it is an aviation “In-Flight Inspection” form. This form can be used if needed, for various secondary company evaluations and is not limited to use in the aviation industry. Rather it can be tailored to any particular industry that has a need for safety audits. Other examples for which this application can be used are the energy and medical industries. Specific to this application is an auditing “process” that can be used in various applications such as hospitals, nuclear power plants, oil as well as gas drilling rigs. However, the application is not just limited to these particular fields, rather it can be used in any field of interest.

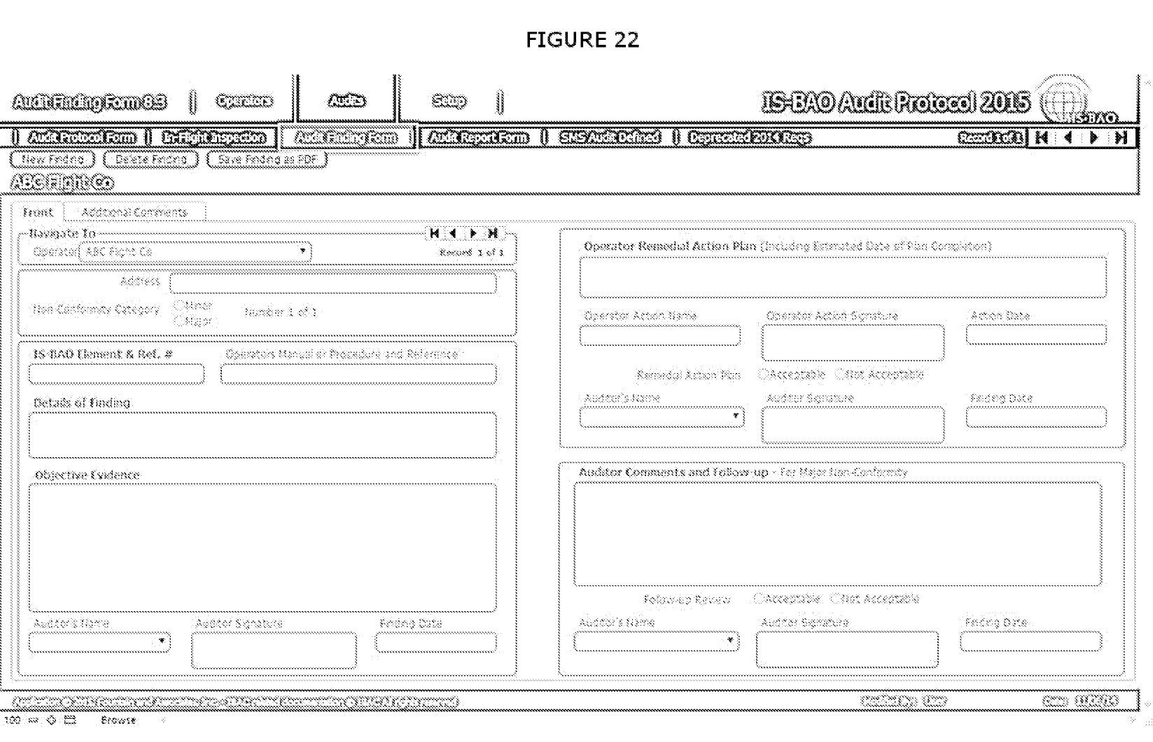

FIG. 22 is a screen shot of the system illustrating the “Audit Findings Form” feature. This is a detailed form used to record findings found during an audit. The Audit Protocol Form has a button that can be used to navigate directly to this form. Multiple forms can be created as needed to record findings during an audit. The “Findings” can also be deleted or saved as a PDF. When an audit is completed the “Findings” can no longer be removed.

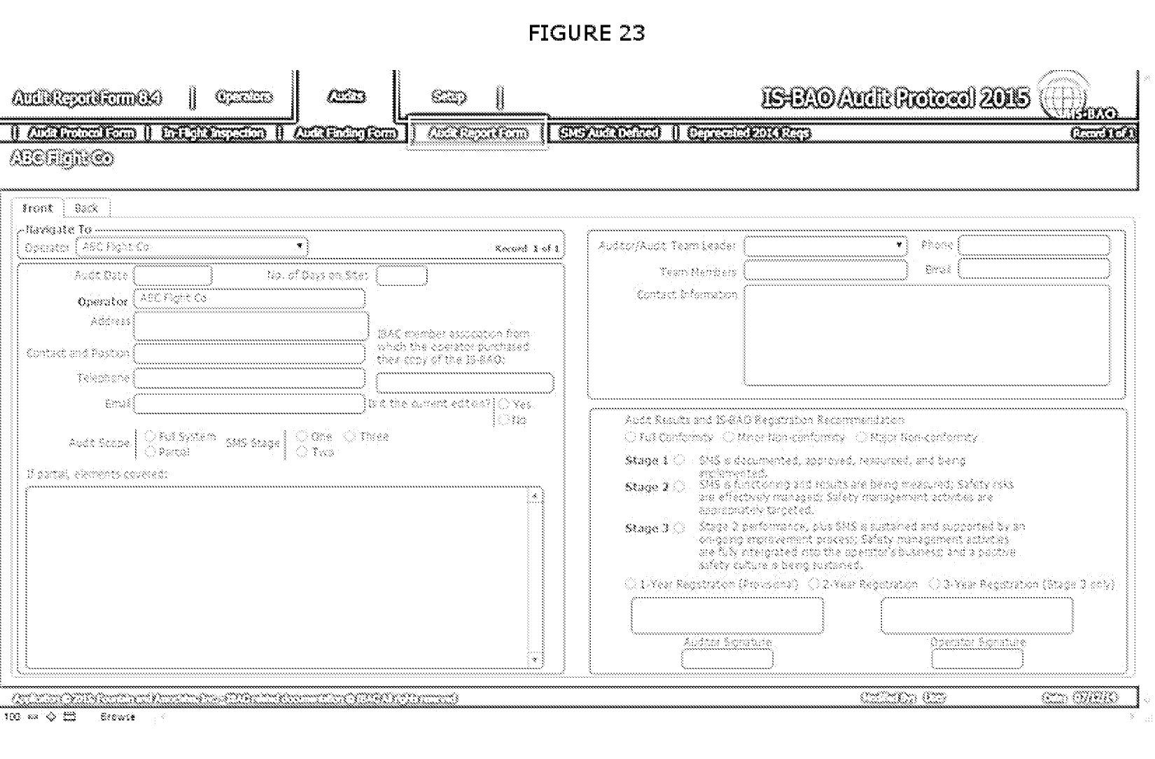

FIG. 23 is a screen shot of the system illustrating the “Audit Report Form.” Typically only one audit report form is filled out for each audit.

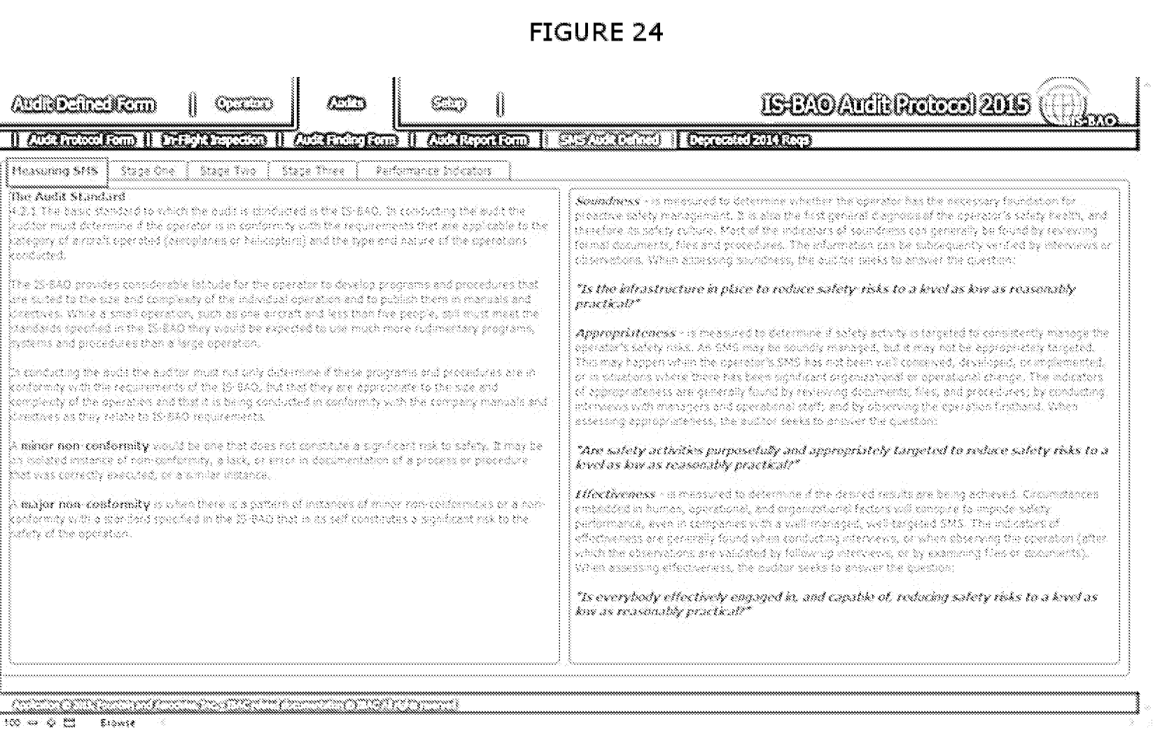

FIG. 24 is a screen shot of the system illustrating the “SMS Audit Defined” feature. It is important that essential information is made available for the development and auditing process. This section is used to define the processes used for a particular industry; this screen shot provides an example of the aviation Safety Management System (SMS). This system is based on progressive stages from one to three with a two-year period between audits. FIG. 24 also illustrates the “Measuring SMS” feature under the “SMS Audit Defined” tab. This tab defines keys definitions used in the auditing process.

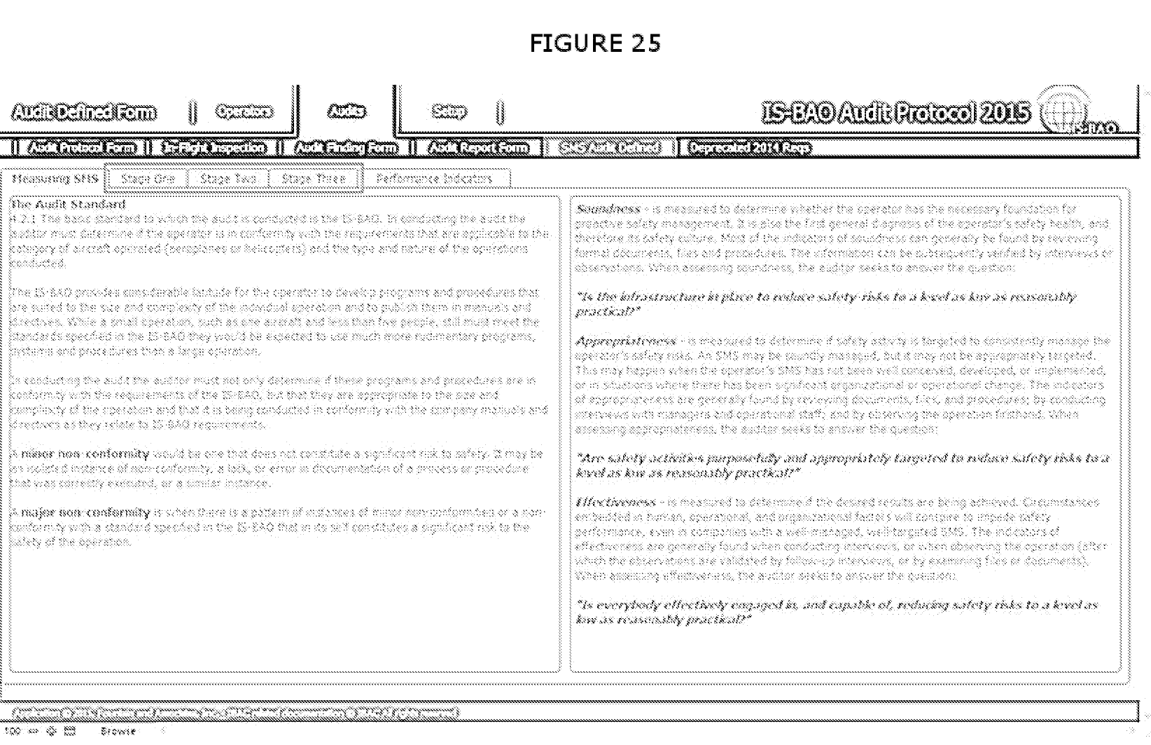

FIG. 25 is a screen shot of the system illustrating the “Stage One” feature under the “Audits” tab. A first stage audit determines if all the required components of a system are in place and personnel understand their role as stakeholders in a Safety Management system. With a sound foundation established, users should be able to provide evidence in two years to advance to a stage two. FIG. 25 also illustrates the “Stage Two” feature under the “Audits” tab. The auditor validates department activities since the last audit to ensure the safety culture is established under the Stage Two feature. FIG. 25 also illustrates the “Stage Three” feature under the “Audits” tab. A high degree of effectiveness has been established and maintained under the Stage Three feature.

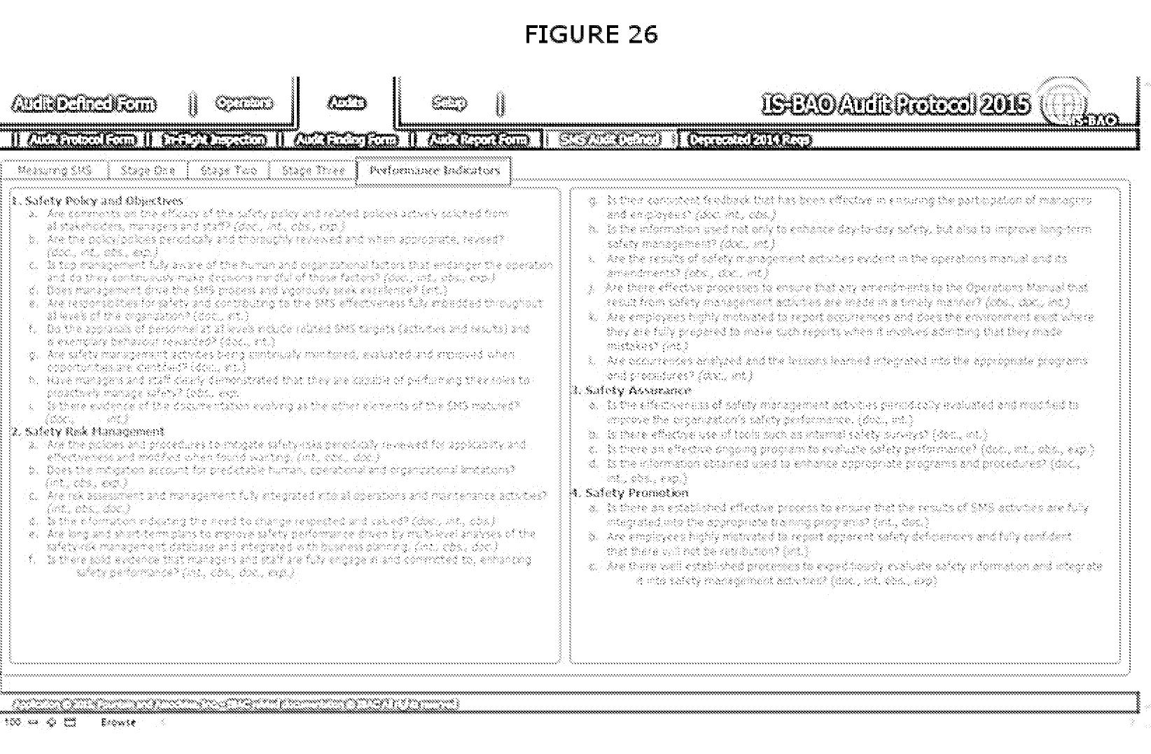

FIG. 26 is a screen shot of the system illustrating the “Performance Indicators” feature under the “Audits” tab. This tab provides a reference to key safety performance indicators in aviation (the example used in this screen shot), or the particular safety information for any field that requires safety audits (not necessarily limited to machine safety audits). Aviation is simply one such industry and is used as an example and should not be construed as limiting this application to only aviation.

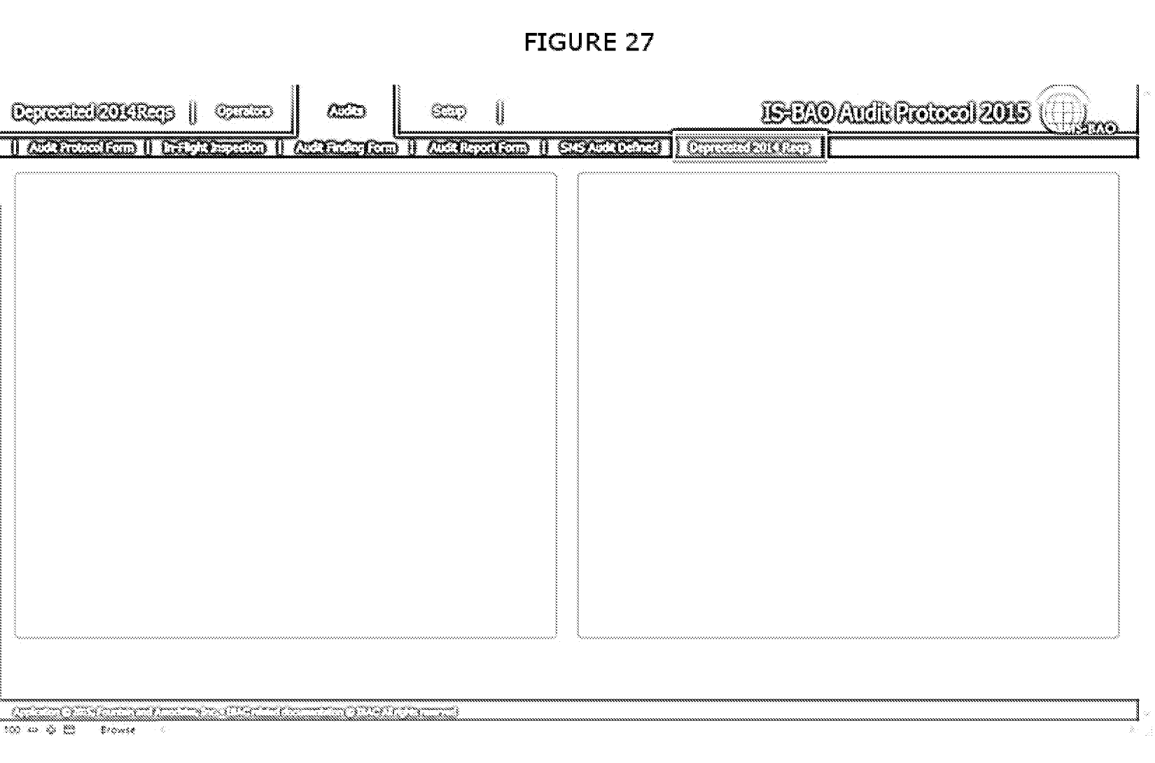

FIG. 27 is a screen shot of the system illustrating the “Depreciated 20XX Requirements” feature under the “Audits” tab. This feature is particular to each specific year. 2014 is the year shown in FIG. 27. When user information is imported from a previous cycle, at times records may not match up with the current protocol. This section acts as a holding area for information not migrated into the current protocol.

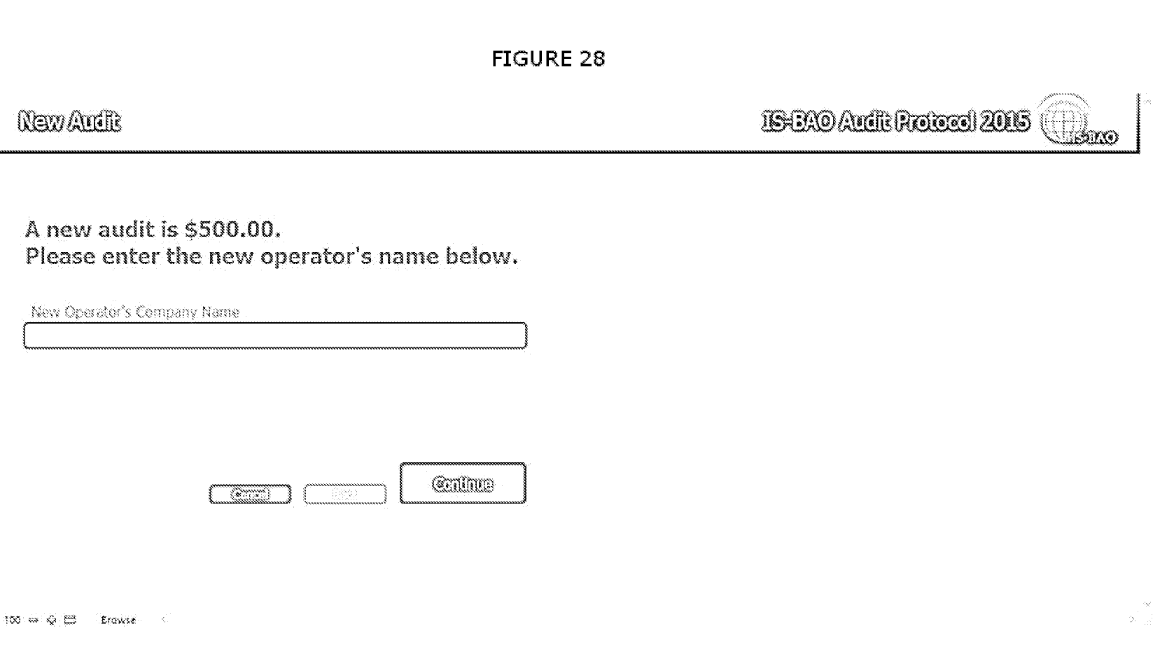

FIG. 28 is a screen shot of the system illustrating the “New Audit” feature.

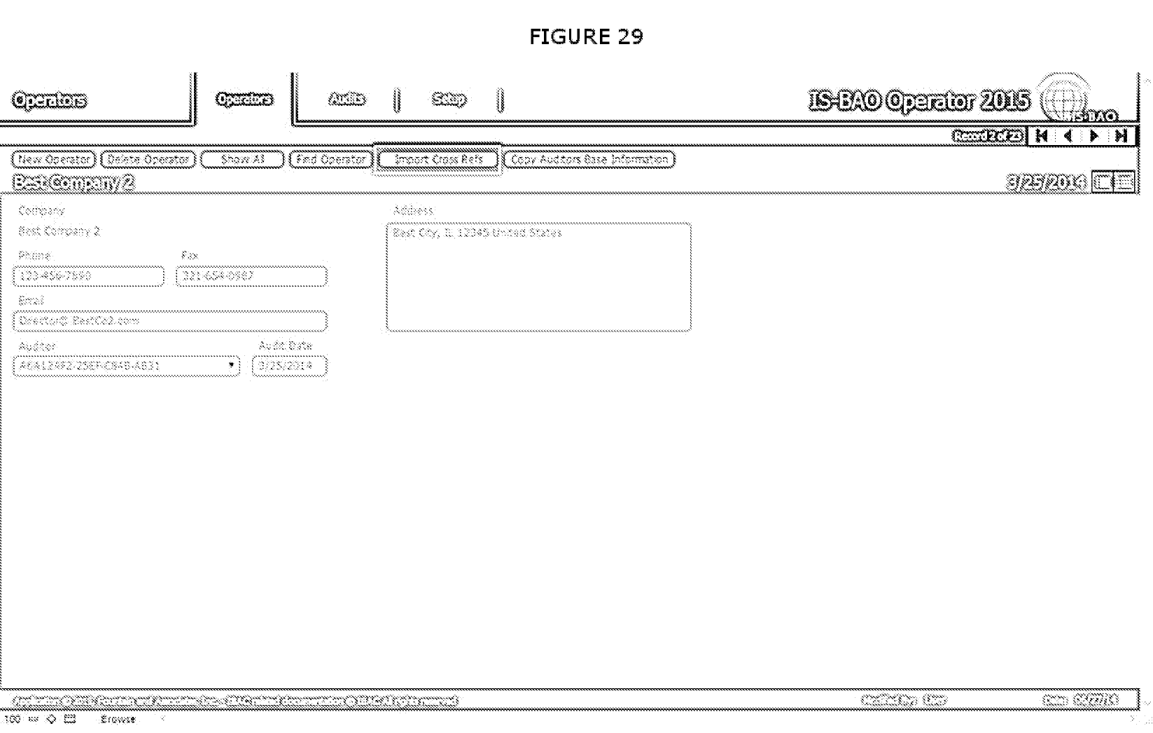

FIG. 29 is a screen shot of the system illustrating several options including the “New Operator” feature under the “Operators” tab. Selection of the “New Operator” button allows an operator to create as many record-sets as needed, during the protocol cycle (which is eighteen months for aviation audits). FIG. 29 also illustrates the “Import Cross References” feature. This feature allows operators to export and auditors to import cross references. Cross references allow operators flexibility in the way they develop their manual systems and provide auditors the ability to quickly reference documents. A significant benefit from cross referencing is in identifying references that do not point to the correct information which can be caused by either a mistake or a misunderstanding of the requirement.

FIG. 29 also illustrates the “Delete Operator,” “Show All” and “Find Operator” features. The “Delete Operator” feature allows operator record sets to be deleted except the auditor's base information and completed audits. The “Show All” feature displays all company audit record sets contained in the current protocol cycle. The “Find Operator” feature provides a means to search for a specific set of records.

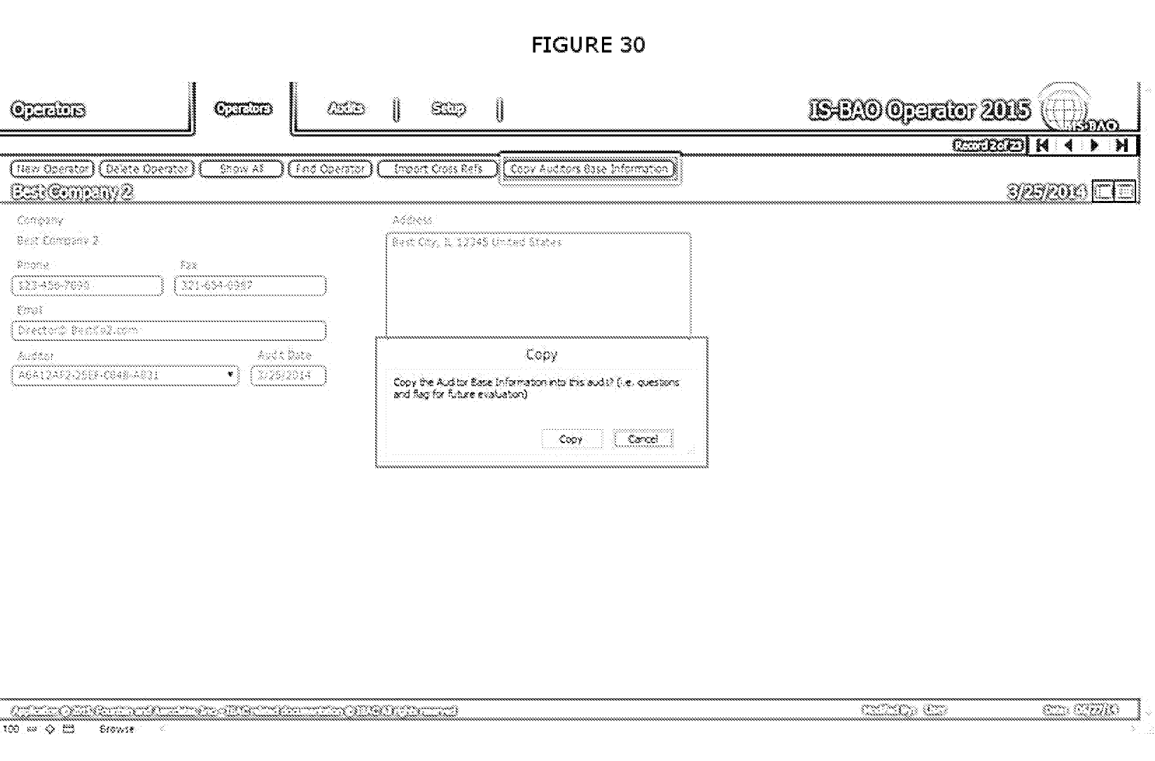

FIG. 30 is a screen shot illustrating the “Copy Auditors Base Information” feature. This process allows a company or outside auditor to set up a new record set with an established auditing style. Once imported, questions can be adjusted during the pre-audit preparation.

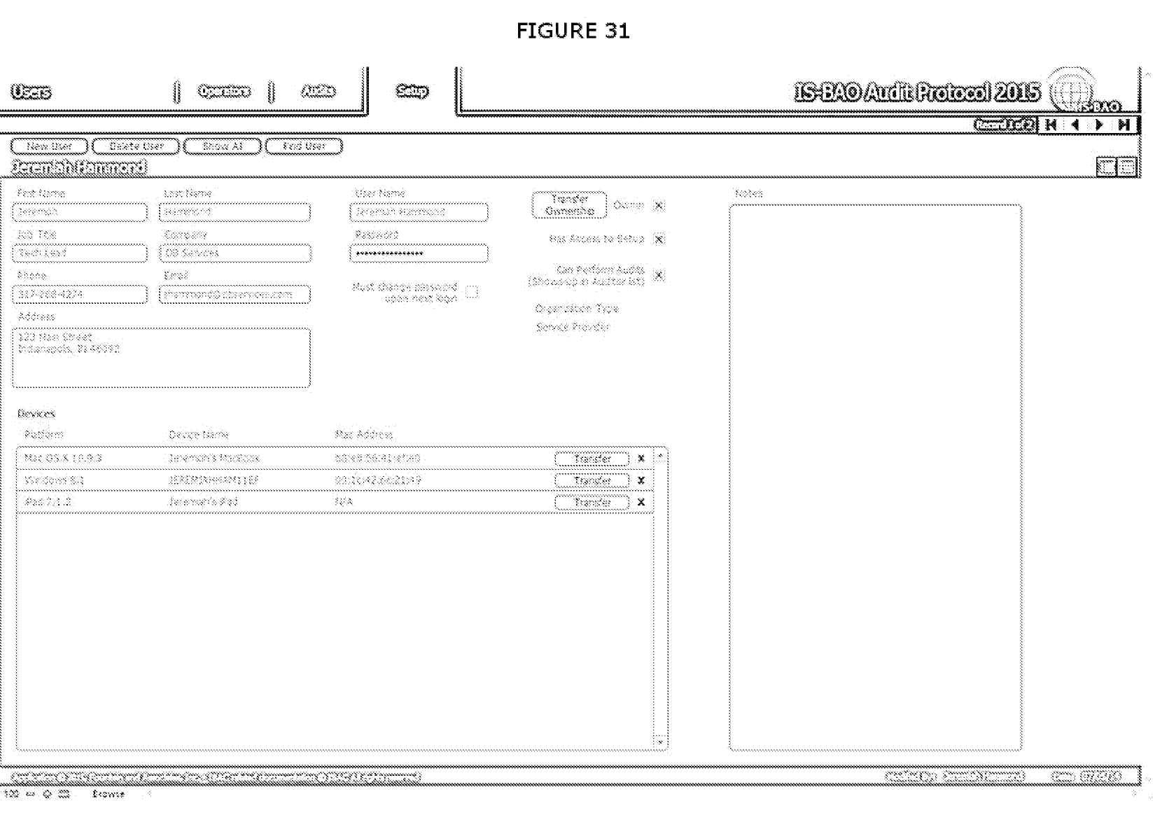

FIGS. 31-35 are screen shots illustrating the various features under the “Setup” function. This function displays users who have access to the application and the devices the company is authorized to use. One of the users is generally an administrator which can be transferred to another person if desired. The administrator can allow other users to have access to setup, perform audits, and change the password upon the next login.

The “New User” tab displays required information needed to incorporate personnel into the application including a user name and an assigned password as is customary in most software applications. The “Delete User” tab allows all users except the owner to be removed from the application. The “Show All” tab displays, in a table view, all users of the application. The “Find User” tab allows the user to enter field information used to search for a particular record.

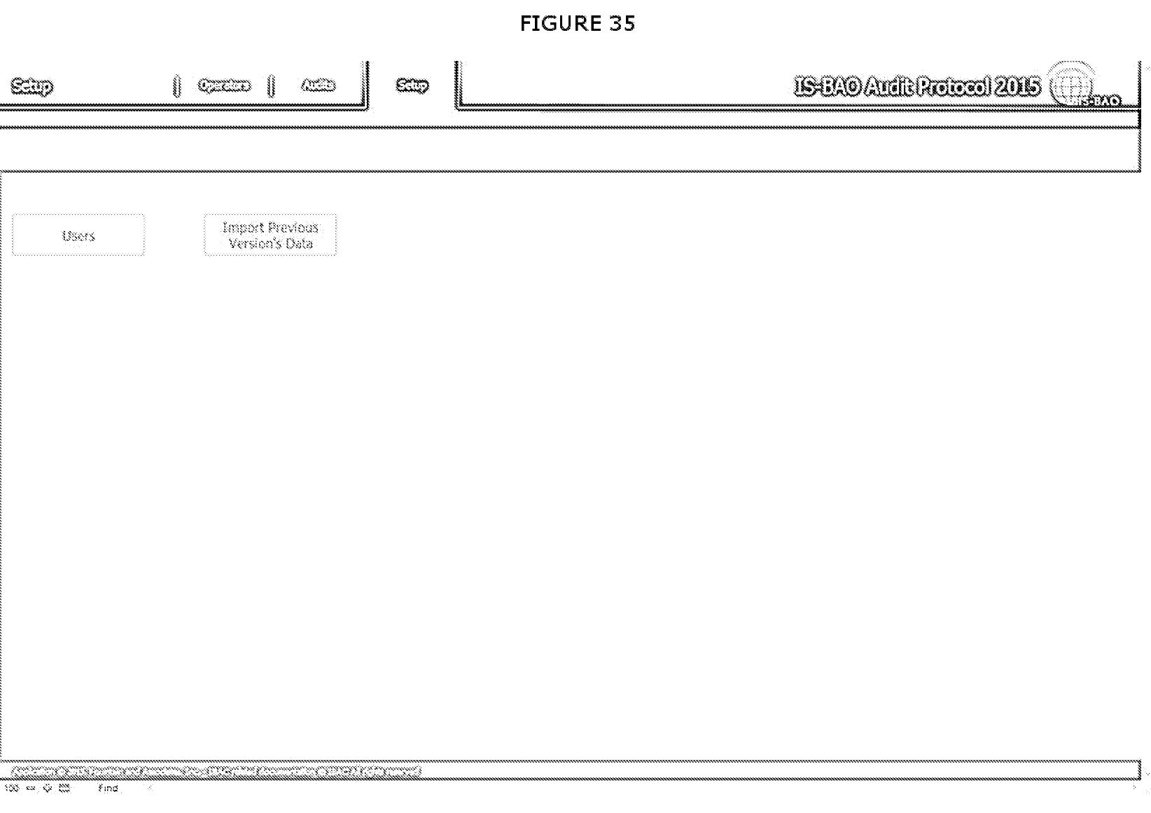

FIG. 35 specifically illustrates the “Import Previous Version's Data” feature which allows the administrator to import company documentation from the previous protocol cycle.

The system disclosed herein can be customized for any industry that requires machine safety audits. Labels and tabs can be changed to conform to specific industry needs and requirements.

Although the inventive software has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A computerized, cloud-based, integrated audit protocol database system for safety audits comprising:
a safety database configured to store at least one safety requirement which is completed and updated by one or more users; and
a compliance audit protocol component that stores and displays industry, regulatory and professional documentation for each safety requirement
wherein a user of the system can prepare and perform internal gap analysis and audits.

2. The system of claim 1 wherein the safety requirements are machine safety requirements.

3. The system of claim 1 further including a database of auditor base information questions for personnel groupings within a department or company.

4. The system of claim 2 wherein the machine safety audits are for the aviation industry, medical industry or energy industry.

5. The system of claim 1 wherein the safety database can exclude a set of requirements if chosen by the user.

6. The system of claim 1 wherein the at least one safety requirement can be completed, updated or manipulated in other ways at the same time by more than one user.
